(19) United States
(12) Patent Application Publication
(10) Pub. No.: US 2025/0141579 A1
(43) Pub. Date: May 1, 2025

(54) SIGNAL PROCESSING METHOD AND COMMUNICATION DEVICE

(71) Applicant: VIVO MOBILE COMMUNICATION CO., LTD., Dongguan (CN)

(72) Inventor: Wei HUANG, Dongguan (CN)

(73) Assignee: VIVO MOBILE COMMUNICATION CO., LTD., Dongguan (CN)

(21) Appl. No.: 19/000,709

(22) Filed: Dec. 24, 2024

Related U.S. Application Data
(63) Continuation of application No. PCT/CN2023/102272, filed on Jun. 26, 2023.

(30) Foreign Application Priority Data
Jun. 29, 2022 (CN) 202210753807.7

(51) Int. Cl. H04J 13/00; H04W 72/231; H04W 72/25

(52) U.S. Cl. CPC H04J 13/0048; H04W 72/231; H04W 72/25

(57) ABSTRACT

A signal processing method is provided. The signal processing method includes: determining, by a first communication device, a first Walsh sequence based on first indication information; performing, by the first communication device, spectrum spreading on an original signal based on the first Walsh sequence to generate a first signal; and transmitting, by the first communication device, the first signal to a second communication device. The first communication device is a device that provides a radio frequency carrier source for the second communication device.

### CROSS-REFERENCE TO RELATED APPLICATIONS

The present application is a continuation of International Application No. PCT/CN2023/102272, filed on Jun. 26, 2023, which claims priority to Chinese Patent Application No. 202210753807.7, filed on Jun. 29, 2022. The entire contents of each of the above-referenced applications are expressly incorporated herein by reference.

### TECHNICAL FIELD

This application pertains to the field of communication technologies, and specifically relates to a signal processing method and a communication device.

### BACKGROUND

Generally, a Backscatter Communication (BSC) system may include a radio frequency source, a backscatter communication transmitting device, and a backscatter communication receiving device. The radio frequency source may provide a radio frequency carrier source for the backscatter communication transmitting device. The backscatter communication transmitting device may perform signal modulation and backscatter on a radio frequency signal, and send an obtained backscatter signal to the backscatter communication receiving device. The backscatter communication receiving device may demodulate the received backscatter signal to implement communication with the backscatter communication transmitting device.

However, in an actual application scenario, when the backscatter communication receiving device receives a signal, the received signal includes not only a backscatter signal sent by the backscatter communication transmitting device, but also a self-interference signal or a direct link interference signal of a same frequency. Therefore, to obtain a useful backscatter signal, the self-interference signal or the direct link interference signal received by the backscatter communication receiving device needs to be eliminated. However, currently, there is no effective technical solution to achieve this objective.

### SUMMARY

Embodiments of this application provide a signal processing method and a communication device.

According to a first aspect, a signal processing method is provided, and the method includes:
determining, by a first communication device, a first Walsh sequence based on first indication information;
performing, by the first communication device, spectrum spreading on an original signal based on the first Walsh sequence to generate a first signal; and
transmitting, by the first communication device, the first signal to a second communication device, where the first communication device is a device that provides a radio frequency carrier source for the second communication device.

According to a second aspect, a signal processing apparatus is provided, and the apparatus includes:
a determining module, configured to determine a first Walsh sequence based on first indication information;
a signal processing module, configured to perform spectrum spreading on an original signal based on the first Walsh sequence to generate a first signal; and
a transmitting module, configured to send the first signal to a second communication device, where the apparatus is an apparatus that provides a radio frequency carrier source for the second communication device.

According to a third aspect, a signal processing method is provided, and the method includes:
receiving, by a second communication device, a first signal, where the first signal is generated after a first communication device performs spectrum spreading on an original signal based on a first Walsh sequence;
determining, by the second communication device, a first target sequence based on third indication information;
generating, by the second communication device, a second signal based on the first target sequence and a backscatter modulation signal, where the backscatter modulation signal is generated by performing modulation and backscatter on the first signal; and
transmitting, by the second communication device, the second signal to a third communication device.

According to a fourth aspect, a signal processing apparatus is provided, and the apparatus includes:
a receiving module, configured to receive a first signal, where the first signal is generated after a first communication device performs spectrum spreading on an original signal based on a first Walsh sequence;
a determining module, configured to determine a first target sequence based on third indication information;
a signal processing module, configured to generate a second signal based on the first target sequence and a backscatter modulation signal, where the backscatter modulation signal is generated by performing modulation and backscatter on the first signal; and
a transmitting module, configured to send the second signal to a third communication device.

According to a fifth aspect, a signal processing method is provided, and the method includes:
receiving, by a third communication device, a first signal and a second signal, where the first signal is generated after a first communication device performs spectrum spreading on an original signal based on a first Walsh sequence, the second signal is generated by a second communication device based on a first target sequence and a backscatter modulation signal, and the backscatter modulation signal is generated after the second communication device performs modulation and backscatter on the first signal;
determining, by the third communication device, a third target sequence based on seventh indication information; and
performing, by the third communication device, spectrum de-spreading on the first signal and the second signal based on the third target sequence.

According to a sixth aspect, a signal processing apparatus is provided, and the apparatus includes:
a receiving module, configured to receive a first signal and a second signal, where the first signal is generated after a first communication device performs spectrum spreading on an original signal based on a first Walsh sequence, the second signal is generated by a second communication device based on a first target sequence and a backscatter modulation signal, and the backscatter modulation signal is generated after the second communication device performs modulation and backscatter on the first signal;
a determining module, configured to determine a third target sequence based on seventh indication information; and
a signal processing module, configured to perform spectrum de-spreading on the first signal and the second signal based on the third target sequence.

According to a seventh aspect, a signal processing method is provided, and the method includes:
configuring or indicating, by a fourth communication device, at least one of a first Walsh sequence, a first target sequence, and a third target sequence, or at least one of a dimension of a Walsh sequence group, a sequence number of the first Walsh sequence, a sequence number of the first target sequence, and a sequence number of the third target sequence to a first communication device, a second communication device, and a third communication device, where
the first Walsh sequence is used by the first communication device to perform spectrum spreading on an original signal to generate a first signal, the first target sequence is used by the second communication device to generate a second signal based on a backscatter modulation signal, the backscatter modulation signal is generated by performing modulation and backscatter on the first signal, and the third target sequence is used by the third communication device to perform spectrum de-spreading on the first signal and the second signal.

According to an eighth aspect, a signal processing apparatus is provided, and the apparatus includes:
a configuration module, configured to configure or indicate at least one of a first Walsh sequence, a first target sequence, and a third target sequence, or at least one of a dimension of a Walsh sequence group, a sequence number of the first Walsh sequence, a sequence number of the first target sequence, and a sequence number of the third target sequence to a first communication device, a second communication device, and a third communication device, where
the first Walsh sequence is used by the first communication device to perform spectrum spreading on an original signal to generate a first signal, the first target sequence is used by the second communication device to generate a second signal based on a backscatter modulation signal, the backscatter modulation signal is generated by performing modulation and backscatter on the first signal, and the third target sequence is used by the third communication device to perform spectrum de-spreading on the first signal and the second signal.

According to a ninth aspect, a communication device is provided, and the communication device includes a processor and a memory. The memory stores a program or an instruction that can be run on the processor, and the program or the instruction is executed by the processor to implement the steps of the method according to the first aspect, the steps of the method according to the third aspect, the steps of the method according to the fifth aspect, or the steps of the method according to the seventh aspect.

According to a tenth aspect, a communication device is provided, including a processor and a communication interface. The processor is configured to: determine a first Walsh sequence based on first indication information; and perform spectrum spreading on an original signal based on the first Walsh sequence to generate a first signal; and the communication interface is configured to send the first signal to a second communication device, where the communication device is a device that provides a radio frequency carrier source for the second communication device; or
the communication interface is configured to receive a first signal, where the first signal is generated after a first communication device performs spectrum spreading on an original signal based on a first Walsh sequence; the processor is configured to determine a first target sequence based on third indication information; and generate a second signal based on the first target sequence and a backscatter modulation signal, where the backscatter modulation signal is generated by performing modulation and backscatter on the first signal; and the communication interface is configured to send the second signal to a third communication device; or
the communication interface is configured to receive a first signal and a second signal, where the first signal is generated after a first communication device performs spectrum spreading on an original signal based on a first Walsh sequence, the second signal is generated by a second communication device based on a first target sequence and a backscatter modulation signal, and the backscatter modulation signal is generated after the second communication device performs modulation and backscatter on the first signal; the processor is configured to determine a third target sequence based on seventh indication information; and the communication interface is configured to perform spectrum de-spreading on the first signal and the second signal based on the third target sequence; or
the communication interface is configured to configure or indicate at least one of a first Walsh sequence, a first target sequence, and a third target sequence, or at least one of a dimension of a Walsh sequence group, a sequence number of the first Walsh sequence, a sequence number of the first target sequence, and a sequence number of the third target sequence to a first communication device, a second communication device, and a third communication device, where the first Walsh sequence is used by the first communication device to perform spectrum spreading on an original signal to generate a first signal, the first target sequence is used by the second communication device to generate a second signal based on a backscatter modulation signal, the backscatter modulation signal is generated by performing modulation and backscatter on the first signal, and the third target sequence is used by the third communication device to perform spectrum de-spreading on the first signal and the second signal.

According to an eleventh aspect, a signal processing system is provided, including at least two of a first communication device, a second communication device, a third communication device, and a fourth communication device. The first communication device may be configured to perform the steps of the signal processing method according to the first aspect, the second communication device may be configured to perform the steps of the signal processing method according to the third aspect, the third communication device may be configured to perform the steps of the signal processing method according to the fifth aspect, and the fourth communication device may be configured to perform the steps of the signal processing method according to the seventh aspect.

According to a twelfth aspect, a readable storage medium is provided. The readable storage medium stores a program or an instruction, and the program or the instruction is executed by a processor to implement the steps of the method according to the first aspect, or the steps of the method according to the third aspect, or the steps of the method according to the fifth aspect, or the steps of the method according to the seventh aspect.

According to a thirteenth aspect, a chip is provided. The chip includes a processor and a communication interface, the communication interface is coupled to the processor, and the processor is configured to run a program or an instruction to implement the method according to the first aspect, or the method according to the third aspect, or the method according to the fifth aspect, or the method according to the seventh aspect.

According to a fourteenth aspect, a computer program/program product is provided. The computer program/program product is stored in a storage medium, and the computer program/program product is executed by at least one processor to implement the steps of the signal processing method according to the first aspect, or the steps of the signal processing method according to the third aspect, or the steps of the signal processing method according to the fifth aspect, or the steps of the signal processing method according to the seventh aspect.

In the embodiments of this application, when transmitting a signal to a second communication device, a first communication device may perform spectrum spreading on an original signal based on an indicated Walsh sequence to obtain a first signal, and send the first signal to the second communication device. When transmitting a backscatter signal to a third communication device, the second communication device may generate a second signal based on the backscatter signal and an indicated first target sequence, and send the second signal to the third communication device. After receiving the first signal and the second signal, the third communication device may perform spectrum de-spreading on the first signal and the second signal based on an indicated third target sequence. Both the first signal and the second signal are signals processed by using Walsh sequences. Therefore, when performing spectrum de-spreading on the first signal and the second signal based on the Walsh sequence, the third communication device may eliminate an interference signal and recover a useful backscatter signal based on characteristics of the Walsh sequence, so as to effectively eliminate the interference signal, thereby ensuring communication performance of backscatter communication and improving transmission efficiency, a transmission distance, and transmission reliability of backscatter communication.

### BRIEF DESCRIPTION OF DRAWINGS

FIG. 1 is a schematic diagram of a wireless communication system according to an embodiment of this application;

FIG. 2 is a schematic diagram of a backscatter communication system according to an embodiment of this application;

FIG. 3 is a schematic flowchart of a signal processing method according to an embodiment of this application;

FIG. 4 is a schematic flowchart of a signal processing method according to an embodiment of this application;

FIG. 5 is a schematic flowchart of a signal processing method according to an embodiment of this application;

FIG. 6 is a schematic flowchart of a signal processing method according to an embodiment of this application;

FIG. 7 is a schematic flowchart of a signal processing method according to an embodiment of this application;

FIG. 8 is a schematic flowchart of a signal processing method according to an embodiment of this application;

FIG. 9 is a schematic diagram of a signal processing method according to an embodiment of this application;

FIG. 10 is a schematic diagram of a signal processing method according to an embodiment of this application;

FIG. 11 is a schematic diagram of a signal processing apparatus according to an embodiment of this application;

FIG. 12 is a schematic structural diagram of a signal processing apparatus according to an embodiment of this application;

FIG. 13 is a schematic structural diagram of a signal processing apparatus according to an embodiment of this application;

FIG. 14 is a schematic structural diagram of a signal processing apparatus according to an embodiment of this application;

FIG. 15 is a schematic structural diagram of a communication device according to an embodiment of this application;

FIG. 16 is a schematic structural diagram of a communication device according to an embodiment of this application; and

FIG. 17 is a schematic structural diagram of a communication device according to an embodiment of this application.

### DETAILED DESCRIPTION

Currently, in a backscatter communication system, a backscatter communication receiving device may receive an interference signal simultaneously when receiving a backscatter signal sent by a backscatter communication transmitting device. For example, in a Monostatic Backscatter Communication System) (MBCS) architecture, a radio frequency source and the backscatter communication receiving device are a same device. The radio frequency source (backscatter communication receiving device) transmits a radio frequency carrier signal to the backscatter communication transmitting device to provide energy and a target carrier, and further receives a useful signal transmitted by the backscatter communication transmitting device for backscatter transmission. Therefore, the radio frequency carrier signal sent by and the backscatter signal received by the radio frequency source (backscatter communication receiving device) are simultaneously on an antenna, frequencies of the two signals are the same, and a signal strength of the radio frequency carrier signal is far greater than a signal strength of the received useful backscatter signal. Consequently, a carrier at the front of the radio frequency source (backscatter communication receiving device) is leaked, resulting in generation of a self-interference signal. A reason for generating the self-interference signal may include three factors: (1) Isolation between transmit and receive ends is limited, so that a carrier at the transmit end is leaked to a front receive end. (2) Antenna mismatch causes the carrier signal to be reflected to the front receive end. (3) Reflection of the carrier signal from an environment enters a receive antenna again.

In a Bistatic Backscatter Communication System (BBCS) architecture, a radio frequency source and a backscatter communication receiving device are two physically separated devices. Therefore, there is no self-interference signal in the monostatic backscatter communication architecture, but direct link interference between the radio frequency source and the backscatter communication receiving device exists. In addition, because the direct link interference may be a modulated signal, and the backscatter communication receiving device generally does not know a modulation characteristic of a direct link signal, a challenge of eliminating the direct link interference is greater.

To eliminate the self-interference signal received by the backscatter communication receiving device, in a related technology, a transmit channel may be isolated from a receive channel in the radio frequency source (backscatter communication receiving device). For example, a dual-antenna structure in which a receive antenna is separated from a transmit antenna, a multi-port circulator, or a coupler is used. Carrier leakage cancellation may be further performed by using a carrier cancellation technology or a self-interference cancellation technology for a leaked carrier. For example, a receive dual-channel cancellation method, a negative feedback loop method, or a dead-area amplifier cancellation method may be used to improve receiver sensitivity.

To eliminate a direct link interference signal received by the backscatter communication receiving device, in a related technology, the direct link interference signal may be treated as noise, and demodulation is performed by using a hard decision, or the backscatter communication receiving device can effectively eliminate strong direct link interference based on characteristics of a time domain structure and a frequency domain structure of the radio frequency carrier signal and in combination with a backscatter baseband signal design.

However, most of the current self-interference signal cancellation solutions rely on the transmit-receive channel isolation or the design of a carrier cancellation circuit, a degree of interference cancellation depends on hardware performance and hardware complexity. In the current direct link interference signal cancellation solution, its decode performance is affected by factors such as a difference between a repetition structure and a channel delay, a receive signal-to-noise ratio, a noise rise, and a decision threshold. In particular, the decision threshold is related to a valid length of the repetition structure and the receive signal-to-noise ratio, and an optimal decision threshold changes with channel conversion. Therefore, demodulation complexity of the solution is high and is susceptible to a transmission environment.

It can be learned that currently, there is still a lack of an effective technical solution to effectively eliminate a self-interference signal or a direct link interference signal received by the backscatter communication receiving device.

The embodiments of this application provide a signal processing method and a communication device. When transmitting a signal to a second communication device, a first communication device may perform spectrum spreading on an original signal based on an indicated Walsh sequence to obtain a first signal, and send the first signal to the second communication device. When transmitting a backscatter signal to a third communication device, the second communication device may generate a second signal based on the backscatter signal and an indicated first target sequence, and send the second signal to the third communication device. After receiving the first signal and the second signal, the third communication device may perform spectrum de-spreading on the first signal and the second signal based on an indicated third target sequence. Both the first signal and the second signal are signals processed by using Walsh sequences. Therefore, when performing spectrum de-spreading on the first signal and the second signal based on the Walsh sequence, the third communication device may eliminate an interference signal and recover a useful backscatter signal based on characteristics of the Walsh sequence, so as to effectively eliminate the interference signal, thereby ensuring communication performance of backscatter communication and improving transmission efficiency, a transmission distance, and transmission reliability of backscatter communication.

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system, a Wi-Fi system, and an RFID system.

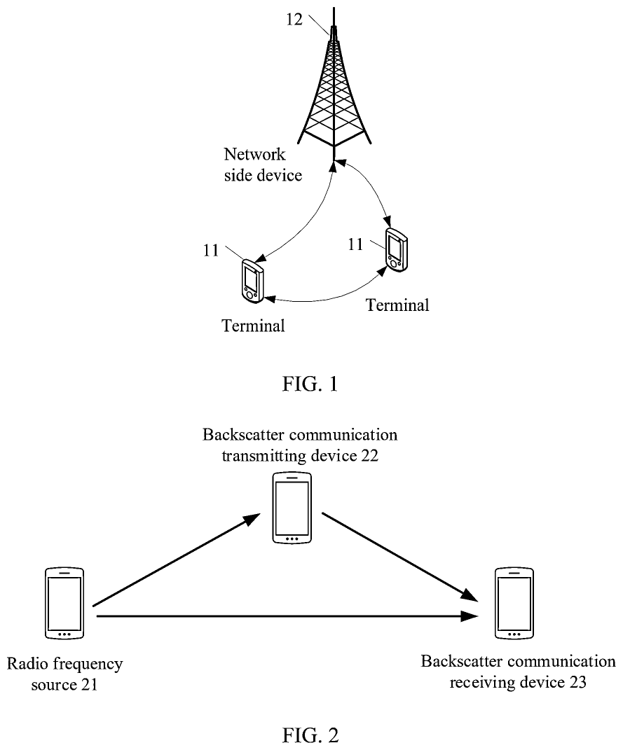

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the field. As long as a same technical effect is achieved, the base station is not limited to a specified technical term. It should be noted that, in this application, only a base station in an NR system is used as an example, and a specific type of the base station is not limited.

FIG. 2 is a block diagram of a backscatter communication system to which the embodiments of this application are applicable. The backscatter communication system includes a radio frequency source 21, a backscatter communication transmitting device 22, and a backscatter communication receiving device 23. The radio frequency source 21 may provide a radio frequency carrier source for the backscatter communication transmitting device 22. The backscatter communication transmitting device 22 may perform backward modulation on a radio frequency signal sent by the radio frequency source 21 and send the signal to the backscatter communication receiving device 23, and the backscatter communication receiving device 23 demodulates the received signal. The radio frequency source 21 may be a dedicated radio frequency source, a terminal or a network side device shown in FIG. 1, or the like. The backscatter communication receiving device 23 may be a reader, a terminal or a network side device shown in FIG. 1, or the like. The backscatter communication transmitting device 22 may be a passive device or a semi-passive device that does not generate a radio frequency signal (a radio frequency signal that uses the radio frequency source), or an active device, such as a sensor or a tag. It should be noted that application scenarios in the embodiments of this application may be a monostatic backscatter communication scenario, or may be a bistatic backscatter communication scenario. In the monostatic backscatter communication scenario, the radio frequency source 21 and the backscatter communication receiving device 23 shown in FIG. 2 are a same device. In the bistatic backscatter communication scenario, the radio frequency source 21 and the backscatter communication receiving device 23 shown in FIG. 2 are different devices.

With reference to the accompanying drawings, the following describes in detail the signal processing method and the communication device provided in the embodiments of this application by using some embodiments and application scenarios thereof.

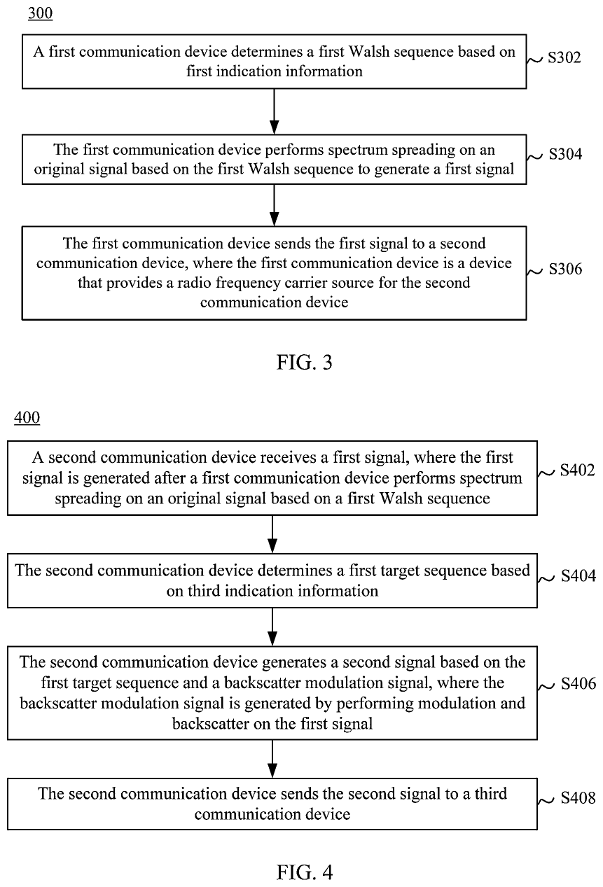

As shown in FIG. 3, an embodiment of this application provides a signal processing method 300. The method may be performed by a first communication device. The first communication device may be the radio frequency source 21 or the backscatter communication receiving device 23 shown in FIG. 2 (in a monostatic backscatter communication scenario). In other words, the signal processing method may be performed by software or hardware installed in the radio frequency source or the backscatter communication receiving device. The signal processing method includes the following steps.

S302. The first communication device determines a first Walsh sequence based on first indication information.

The first communication device is a device that provides a radio frequency carrier source. For example, in a monostatic backscatter communication architecture, the first communication device may be a radio frequency source and a backscatter communication receiving device (the radio frequency source and the backscatter communication receiving device are a same device). In a bistatic backscatter communication architecture, the first communication device may be a radio frequency source.

In this embodiment of this application, the first communication device may determine the first Walsh sequence based on the first indication information before transmitting an original signal. The first Walsh sequence may be used by the first communication device to perform spectrum spreading on the original signal, where the original signal may be a radio frequency carrier signal or the like.

The first indication information may be used to indicate the first Walsh sequence or indicate a dimension of a Walsh sequence group to which the first Walsh sequence belongs and a sequence number of the first Walsh sequence. In a case that the first indication information is used to indicate the first Walsh sequence, the first communication device may directly determine the first Walsh sequence based on the first indication information. In a case that the first indication information is used to indicate the dimension of the Walsh sequence group to which the first Walsh sequence belongs and the sequence number of the first Walsh sequence, the first communication device may first determine the Walsh sequence group based on the dimension of the Walsh sequence group, and then determine the first Walsh sequence in the Walsh sequence group based on the sequence number. In a possible implementation, the first indication information may indicate only the dimension of the Walsh sequence group to which the first Walsh sequence belongs. When determining the first Walsh sequence, the first communication device may first determine the Walsh sequence group based on the dimension of the Walsh sequence group, and then independently select a Walsh sequence from the Walsh sequence group as the first Walsh sequence.

In an embodiment, the first indication information may be configured or indicated by a fourth communication device. The fourth communication device may be the first communication device, a second communication device, a third communication device, or a third-party network device. In other words, the first communication device may independently configure or indicate the first Walsh sequence used by the first communication device, or another communication device configures or indicates the first Walsh sequence to the first communication device. The second communication device may be a backscatter communication transmitting device, the third communication device may be a backscatter communication receiving device, and the third-party network device may be another device other than the radio frequency source, the backscatter communication transmitting device, and the backscatter communication receiving device, for example, may be a base station, a reader/writer device, a relay device, or another terminal device.

In an embodiment, in a case that the first indication information is configured or indicated by the fourth communication device and the fourth communication device is different from the first communication device, before the first communication device determines the first Walsh sequence based on the first indication information, the method further includes:
receiving the first indication information.

In other words, in a case that the first indication information is configured or indicated by another communication device other than the first communication device, the first communication device further needs to receive the first indication information before determining the first Walsh sequence based on the first indication information. The first indication information may be configured or indicated by another communication device by using at least one of Radio Resource Control (RRC) signaling, a Medium Access Control Control Element (MAC CE), Downlink Control Information (DCI), Sidelink Control Information (SCI), and a preamble sequence.

S304. The first communication device performs spectrum spreading on an original signal based on the first Walsh sequence to generate a first signal.

After determining the first Walsh sequence, the first communication device may perform spectrum spreading processing on the original signal by using the first Walsh sequence to obtain the first signal.

S306. The first communication device sends the first signal to a second communication device, where the first communication device is a device that provides a radio frequency carrier source for the second communication device.

The second communication device may be a backscatter communication transmitting device, and the first communication device provides the radio frequency carrier source for the second communication device. After performing spectrum spreading on the original signal to obtain the first signal by using the first Walsh sequence, the first communication device may send the first signal to the second communication device.

In an embodiment, the first communication device may indicate the first Walsh sequence used by the first communication device to the second communication device or to the second communication device and the third communication device, where the third communication device is a backscatter communication receiving device. For example, the method may include:
transmitting, by the first communication device, second indication information to the second communication device and the third communication device in a case that the first communication device and the third communication device are different devices; and
transmitting, by the first communication device, the second indication information to the second communication device in a case that the first communication device and the third communication device are a same device, where
the second indication information is used to indicate the first Walsh sequence or indicate a dimension of a Walsh sequence group to which the first Walsh sequence belongs and a sequence number of the first Walsh sequence.

For example, in a monostatic backscatter communication architecture, the first communication device and the third communication device are a same device, that is, a radio frequency source and a backscatter communication receiving device are a same device. In this case, when transmitting the second indication information, the first communication device may send only the second indication information to the second communication device. In a bistatic backscatter communication architecture, the first communication device and the third communication device are different devices, that is, a radio frequency source and a backscatter communication receiving device are different devices. In this case, when transmitting the second indication information, the first communication device may send the second indication information to the second communication device and the third communication device.

In an embodiment, when transmitting the second indication information to the second communication device or to the second communication device and the third communication device, the first communication device may send the second indication information by using at least one of RRC signaling, a MAC CE, DCI, SCI, and a preamble sequence.

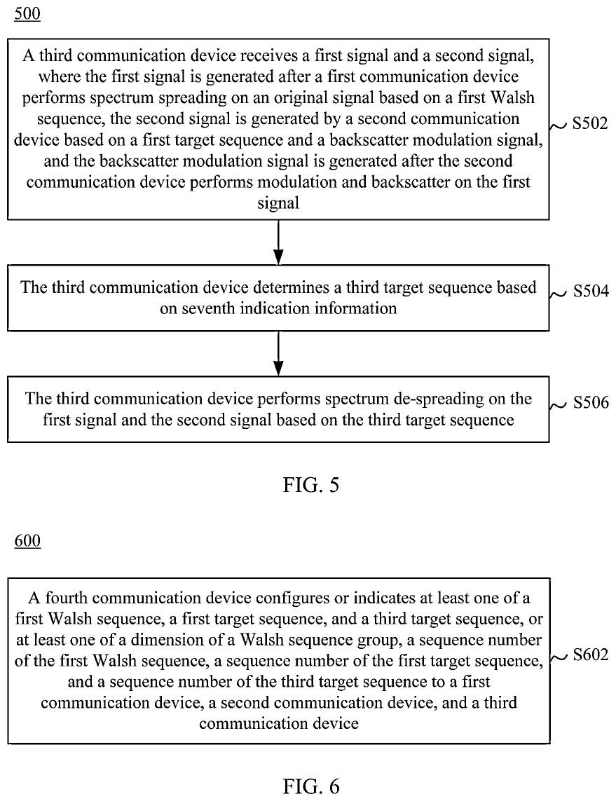

It should be noted that the foregoing scenario in which the first communication device sends the second indication information to the second communication device or to the second communication device and the third communication device may be a scenario in which the fourth communication device does not uniformly configure or indicate a Walsh sequence to the second communication device and the third communication device. In this case, the first communication device needs to send the second indication information to the second communication device or to the second communication device and the third communication device, so that the second communication device may determine the first target sequence based on the second indication information, and the third communication device may determine a third target sequence based on the second indication information. For details, refer to corresponding content in the embodiments shown in FIG. 4 and FIG. 5. If the fourth communication device uniformly configures or indicates the Walsh sequence to the second communication device and the third communication device, the first communication device may not need to send the second indication information to the second communication device or to the second communication device and the third communication device, so as to avoid a waste of transmission resources.

In this embodiment of this application, when transmitting a signal to a second communication device, a first communication device may perform spectrum spreading on an original signal based on an indicated Walsh sequence to obtain a first signal, and send the first signal to the second communication device. In this way, spectrum spreading processing is performed on a signal by using a Walsh sequence, so that when performing spectrum de-spreading on a received signal, the third communication device may eliminate an interference signal and recover a useful backscatter signal based on characteristics of the Walsh sequence, so as to effectively eliminate the interference signal, thereby ensuring communication performance of backscatter communication and improving transmission efficiency, a transmission distance, and transmission reliability of backscatter communication.

As shown in FIG. 4, an embodiment of this application provides a signal processing method 400. The method may be performed by a second communication device. The second communication device may be the backscatter communication transmitting device 22 shown in FIG. 2. In other words, the signal processing method may be performed by software or hardware installed in the backscatter communication transmitting device. The signal processing method includes the following steps.

S402. The second communication device receives a first signal, where the first signal is generated after a first communication device performs spectrum spreading on an original signal based on a first Walsh sequence.

After generating the first signal, the first communication device may send the first signal to the second communication device, and the second communication device may receive the first signal. For an implementation in which the first communication device generates the first signal based on the first Walsh sequence, refer to the embodiment shown in FIG. 3. Details are not described herein again.

S404. The second communication device determines a first target sequence based on third indication information.

After receiving the first signal, the second communication device may determine the first target sequence based on the third indication information. The first target sequence may be used by the second communication device to generate a second signal based on a backscatter modulation signal, where the backscatter modulation signal is generated by the second communication device by performing modulation and backscatter on the first signal, and the second signal is sent by the second communication device to a third communication device.

In an embodiment, the third indication information may be indicated by the first communication device. In a case that the third indication information is indicated by the first communication device, the third indication information may be used to indicate the first Walsh sequence or indicate a dimension of a Walsh sequence group to which the first Walsh sequence belongs and a sequence number of the first Walsh sequence. The third indication information herein may be the second indication information in the embodiment shown in FIG. 3.

In an embodiment, the third indication information may be configured or indicated by a fourth communication device. The fourth communication device may be the first communication device, the second communication device, the third communication device, or a third-party network device. In other words, the third indication information may be independently configured or indicated by the second communication device, or may be configured or indicated by another communication device. In a case that the third indication information is configured or indicated by the fourth communication device, the third indication information may be used to indicate any one of the following (1) and (2):
(1) a second Walsh sequence in the Walsh sequence group (that is, the Walsh sequence group to which the first Walsh sequence belongs), or the dimension of the Walsh sequence group and a sequence number of the second Walsh sequence, where the second Walsh sequence is different from the first Walsh sequence, that is, the second Walsh sequence is a Walsh sequence other than the first Walsh sequence in the Walsh sequence group to which the first Walsh sequence belongs; and
(2) a third Walsh sequence and a fourth Walsh sequence in the Walsh sequence group (that is, the Walsh sequence group to which the first Walsh sequence belongs), or the dimension of the Walsh sequence group, a sequence number of the third Walsh sequence, and a sequence number of the fourth Walsh sequence, where the third Walsh sequence, the fourth Walsh sequence, and the first Walsh sequence are different from each other, and the third Walsh sequence, the fourth Walsh sequence, and the first Walsh sequence belong to a same Walsh sequence group, but the three sequences are different from each other.

In an embodiment, in a case that the third indication information is indicated by the first communication device, or is configured or indicated by the fourth communication device and the fourth communication device is not the second communication device, before the second communication device determines the first target sequence based on the third indication information, the method further includes:
receiving the third indication information.

The third indication information may be configured or indicated by using at least one of RRC signaling, a MAC CE, DCI, SCI, and a preamble sequence.

Considering that the third indication information may be indicated by the first communication device or the fourth communication device and third indication information indicated by different devices is different, the second communication device may determine the first target sequence based on the third indication information in two implementations. The following separately describes the two implementations.

In an implementation, in a case that the third indication information is indicated by the first communication device, that is, the third indication information is used to indicate the first Walsh sequence or indicates the dimension of the Walsh sequence group to which the first Walsh sequence belongs and the sequence number of the first Walsh sequence, that the second communication device determines the first target sequence based on the third indication information may include the following S4041 to S4043:

S4041. Determine the first Walsh sequence based on the third indication information.

In a case that the third indication information is used to indicate the first Walsh sequence, the second communication device may directly determine the first Walsh sequence based on the third indication information.

In a case that the third indication information is used to indicate the dimension of the Walsh sequence group to which the first Walsh sequence belongs and the sequence number of the first Walsh sequence, the second communication device may first determine the Walsh sequence group based on the dimension of the Walsh sequence group, and then determine the first Walsh sequence in the Walsh sequence group based on the sequence number.

S4042. Determine a use manner of the first target sequence based on fourth indication information.

The use manner of the first target sequence may include a first manner or a second manner. The first manner represents a manner of performing chip-level multiplication on the first target sequence and the first Walsh sequence based on a multiplication principle, and the second manner represents a manner of performing equal-amplitude superposition and mapping processing on the first target sequence and the first Walsh sequence based on an equal-amplitude superposition principle. The fourth indication information may be used to indicate the use manner of the first target sequence. The second communication device may determine, based on the fourth indication information, whether the use manner of the first target sequence is the first manner or the second manner.

In an embodiment, the fourth indication information may be configured or indicated by a fourth communication device, and the fourth communication device is the first communication device, the second communication device, the third communication device, or a third-party network device. In a case that the fourth communication device is not the second communication device, before the second communication device determines the use manner of the first target sequence based on the fourth indication information, the method further includes:
receiving the fourth indication information.

The fourth indication information may be configured or indicated by the fourth communication device by using at least one of RRC signaling, a MAC CE, DCI, SCI, and a preamble sequence.

S4043. Determine the first target sequence based on the first Walsh sequence and the use manner of the first target sequence.

For example, when determining, based on the fourth indication information, that the use manner of the first target sequence is the first manner, the second communication device may determine the second Walsh sequence based on the first Walsh sequence, and then determine the second Walsh sequence as the first target sequence. The second Walsh sequence and the first Walsh sequence belong to a same Walsh sequence, and the second Walsh sequence and the first Walsh sequence are different. When determining the second Walsh sequence based on the first Walsh sequence, the second communication device may independently select, as the second Walsh sequence, a Walsh sequence other than the first Walsh sequence from the Walsh sequence group to which the first Walsh sequence belongs.

When determining, based on the fourth indication information, that the use manner of the first target sequence is the second manner, the second communication device may determine the third Walsh sequence and the fourth Walsh sequence based on the first Walsh sequence, and determine the third Walsh sequence and the fourth Walsh sequence as the first target sequence. The third Walsh sequence, the fourth Walsh sequence, and the first Walsh sequence belong to a same Walsh sequence, and the third Walsh sequence, the fourth Walsh sequence, and the first Walsh sequence are different from each other. When determining the third Walsh sequence and the fourth Walsh sequence based on the first Walsh sequence, the second communication device may independently select, as the third Walsh sequence and the fourth Walsh sequence, two different Walsh sequences other than the first Walsh sequence from the Walsh sequence group to which the first Walsh sequence belongs.

In another implementation, in a case that the third indication information is configured or indicated by the fourth communication device, that the second communication device determines the first target sequence based on the third indication information may include the following two cases.

In a case that the third indication information is used to indicate the second Walsh sequence in the Walsh sequence group or indicates the dimension of the Walsh sequence group and the sequence number of the second Walsh sequence, the second communication device may determine the second Walsh sequence based on the third indication information, and determine the second Walsh sequence as the first target sequence.

In a case that the third indication information is used to indicate the third Walsh sequence and the fourth Walsh sequence in the Walsh sequence group or indicates the dimension of the Walsh sequence group, the sequence number of the third Walsh sequence, and the sequence number of the fourth Walsh sequence, the second communication device may determine the third Walsh sequence and the fourth Walsh sequence based on the third indication information, and then determine the third Walsh sequence and the fourth Walsh sequence as the first target sequence.

S406. The second communication device generates a second signal based on the first target sequence and a backscatter modulation signal, where the backscatter modulation signal is generated by performing modulation and backscatter on the first signal.

After receiving the first signal, the second communication device may perform modulation and backscatter on the first signal based on a baseband signal, to generate a backscatter signal. After the backscatter signal is generated, the second signal may be generated based on the first target sequence determined in S404 and the backscatter signal.

Considering that the first target sequence may be the second Walsh sequence (determined by the second communication device based on the first Walsh sequence or indicated by the fourth communication device) or the third Walsh sequence and the fourth Walsh sequence (determined by the second communication device based on the first Walsh sequence or indicated by the fourth communication device), that the second signal is generated based on the first target sequence and the backscatter signal may include the following two cases.

Case 1: The first target sequence is the second Walsh sequence.

In a case that the first target sequence is the second Walsh sequence, that the second communication device generates the second signal based on the first target sequence and the backscatter modulation signal may include:
performing chip-level multiplication on the second Walsh sequence and the backscatter modulation signal to obtain the second signal.

It should be noted that the second signal obtained herein includes a Walsh sequence obtained after chip-level multiplication is performed on the first Walsh sequence and the second Walsh sequence, and the Walsh sequence is the second target sequence recorded in the foregoing S404.

Case 2: The first target sequence is the third Walsh sequence and the fourth Walsh sequence.

In a case that the first target sequence is the third Walsh sequence and the fourth Walsh sequence, that the second communication device generates the second signal based on the first target sequence and the backscatter modulation signal may include:
performing equal-amplitude superposition and mapping processing on the third Walsh sequence, the fourth Walsh sequence, and the backscatter modulation signal to obtain the second signal.

It should be noted that the second signal obtained herein includes a Walsh sequence obtained by performing equal-amplitude superposition and mapping processing on the first Walsh sequence, the third Walsh sequence, and the fourth Walsh sequence.

S408. The second communication device sends the second signal to the third communication device.

The third communication device may be a backscatter communication receiving device. The second communication device may send the second signal to the third communication device after generating the second signal, so that the third communication device performs spectrum de-spreading. For details, refer to the embodiment shown in FIG. 5. Details are not described herein.

In an embodiment, in a case that the first target sequence is determined by the second communication device based on the first Walsh sequence indicated by the first communication device, that is, in a case that the second communication device determines the second Walsh sequence as the first target sequence or determines the third Walsh sequence and the fourth Walsh sequence as the first target sequence in the first manner or the second manner in S404, the second communication device may further indicate the related Walsh sequence to the third communication device.

The second communication device may send fifth indication information to the third communication device in a case that the second Walsh sequence is determined as the first target sequence in the first manner. The fifth indication information is used to indicate any one of the following:
the second Walsh sequence, or the dimension of the Walsh sequence group to which the second Walsh sequence belongs and the sequence number of the second Walsh sequence; and
a second target sequence, or a dimension of a Walsh sequence group (a Walsh sequence group the same as the Walsh sequence group to which the first Walsh sequence and the second Walsh sequence belong) to which the second target sequence belongs and a sequence number of the second target sequence, where the sequence number of the second target sequence is equal to a modulo 2 addition of binary representations of the sequence number of the first Walsh sequence and the sequence number of the second Walsh sequence.

The second communication device may send sixth indication information to the third communication device in a case that the third Walsh sequence and the fourth Walsh sequence are determined as the first target sequence based on the second manner. The sixth indication information may be used to indicate the third Walsh sequence and the fourth Walsh sequence or indicate the dimension of the Walsh sequence group to which the third Walsh sequence and the fourth Walsh sequence belong, the sequence number of the third Walsh sequence, and the sequence number of the fourth Walsh sequence.

When transmitting the fifth indication information or the sixth indication information to the third communication device, the second communication device may send the fifth indication information or the sixth indication information to the third communication device by using at least one of RRC signaling, a MAC CE, DCI, SCI, and a preamble sequence.

In this embodiment of this application, a first communication device may perform spectrum spreading on an original signal based on an indicated Walsh sequence to obtain a first signal, and send the first signal to a second communication device. The second device performs modulation and backscatter on the first signal to generate a backscatter signal, and sends a second signal to a third communication device based on an indicated first target sequence and the backscatter signal. In this way, a signal is processed by using a Walsh sequence, so that when performing spectrum de-spreading on a received signal, the third communication device may eliminate an interference signal and recover a useful backscatter signal based on characteristics of the Walsh sequence, so as to effectively eliminate the interference signal, thereby ensuring communication performance of backscatter communication and improving transmission efficiency, a transmission distance, and transmission reliability of backscatter communication.

As shown in FIG. 5, an embodiment of this application provides a signal processing method 500. The method may be performed by a third communication device. The third communication device may be the backscatter communication receiving device 23 or the radio frequency source 21 shown in FIG. 2 (in a scenario of a monostatic backscatter communication architecture). In other words, the signal processing method may be performed by software or hardware installed in the backscatter communication receiving device or the radio frequency source. The signal processing method includes the following steps.

S502. The third communication device receives a first signal and a second signal, where the first signal is generated after a first communication device performs spectrum spreading on an original signal based on a first Walsh sequence, the second signal is generated by a second communication device based on a first target sequence and a backscatter modulation signal, and the backscatter modulation signal is generated after the second communication device performs modulation and backscatter on the first signal.

After performing spectrum spreading on the original signal based on the first Walsh sequence to generate the first signal, the first communication device may send the first signal to the second communication device. After receiving the first signal, the second communication device may perform modulation and backscatter on the first signal to generate the backscatter signal, then generate the second signal based on the first target sequence and the backscatter signal, and send the second signal to the third communication device. For an implementation of generating the first signal by the first communication device, refer to the embodiment shown in FIG. 3. For an implementation of generating the second signal by the second communication device, refer to the embodiment shown in FIG. 4. Details are not described herein again.

For the third communication device, when receiving a signal, the third communication device may receive not only the second signal sent by the second communication device, but also the first signal sent by the first communication device. For the third communication device, the second signal is a useful signal, and the first signal is an interference signal that needs to be eliminated. The interference signal may be a self-interference signal (for a monostatic backscatter communication architecture) or a direct link interference signal (for a bistatic backscatter communication architecture).

S504. The third communication device determines a third target sequence based on seventh indication information.

After receiving the first signal and the second signal, the third communication device may determine the third target sequence based on the seventh indication information. The third target sequence may be used by the third communication device to perform spectrum de-spreading on the first signal and the second signal, so as to eliminate an interference signal and recover a useful signal.

In an embodiment, the seventh indication information may be configured or indicated by a fourth communication device. The fourth communication device is the first communication device, the second communication device, the third communication device, or a third-party network device. In a case that the seventh indication information is configured or indicated by the fourth communication device, the seventh indication information may be used to indicate the third target sequence or indicate a dimension of a Walsh sequence group to which the third target sequence belongs and a sequence number of the third target sequence.

In an embodiment, the seventh indication information may be indicated by the second communication device. In a case that the seventh indication information is indicated by the second communication device, the seventh indication information may be used to indicate any one of the following (1) to (3):
(1) a second Walsh sequence, or a dimension of a Walsh sequence group to which the second Walsh sequence belongs and a sequence number of the second Walsh sequence, where the second Walsh sequence belongs to a same Walsh sequence group as the first Walsh sequence and is different from the first Walsh sequence;
(2) a second target sequence, or a dimension of a Walsh sequence group to which the second target sequence belongs and a sequence number of the second target sequence, where the sequence number of the second target sequence is equal to a modulo 2 addition of binary representations of a sequence number of the first Walsh sequence and the sequence number of the second Walsh sequence; and
(3) a third Walsh sequence and a fourth Walsh sequence, or a dimension of a Walsh sequence group to which the third Walsh sequence and the fourth Walsh sequence belong, a sequence number of the third Walsh sequence, and a sequence number of the fourth Walsh sequence, where the third Walsh sequence, the fourth Walsh sequence, and the first Walsh sequence are different from each other.

In a case that the seventh indication information is used to indicate the foregoing (1) or (2), the seventh indication information may be the fifth indication information in the embodiment shown in FIG. 3. In a case that the seventh indication information is used to indicate the foregoing (3), the seventh indication information may be the sixth indication information in the embodiment shown in FIG. 4. For details, refer to the descriptions of the fifth indication information and the sixth indication information in the embodiment shown in FIG. 4. Details are not described herein again.

In an embodiment, in a case that the seventh indication information is indicated by the second communication device or is configured or indicated by the fourth communication device and the fourth communication device is not the third communication device, before the third communication device determines the third target sequence based on the seventh indication information, the method further includes:
receiving the seventh indication information.

The seventh indication information is configured or indicated by the second communication device or the fourth communication device by using at least one of RRC signaling, a MAC CE, DCI, SCI, and a preamble sequence.

In this embodiment of this application, considering that the seventh indication information may be indicated by the second communication device or the fourth communication device and seventh indication information indicated by different devices is different, the third communication device may determine the third target sequence based on the seventh indication information in at least four implementations. The following separately describes the four implementations.

In a first implementation, in a case that the seventh indication information is indicated by the second communication device, and the seventh indication information is used to indicate the second target sequence or indicate the dimension of the Walsh sequence group to which the second target sequence belongs and the sequence number of the second target sequence, that the third communication device determines the third target sequence based on the seventh indication information may include:
determining a second target sequence based on the seventh indication information; and
determining the second target sequence as the third target sequence.

In other words, the third communication device may use the second target sequence indicated by the second communication device as the third target sequence.

It should be noted that an application scenario corresponding to the first implementation may be as follows: The second communication device generates the second signal based on the second Walsh sequence and the backscatter signal, then performs chip-level multiplication on the first Walsh sequence and the second Walsh sequence to obtain the second target sequence, and indicates, to the third communication device by using the fifth indication information, the second target sequence, or the dimension of the Walsh sequence group to which the second target sequence belongs and the sequence number of the second target sequence, and the third communication device determines the second target sequence as the third target sequence based on the indication of the second communication device.

In a second implementation, in a case that the seventh indication information is indicated by the second communication device, and the seventh indication information is used to indicate the second Walsh sequence or indicate the dimension of the Walsh sequence group to which the second Walsh sequence belongs and the sequence number of the second Walsh sequence, that the third communication device determines the third target sequence based on the seventh indication information may include:
determining the first Walsh sequence based on second indication information, where the second indication information is used to indicate the first Walsh sequence or indicate the dimension of the Walsh sequence group to which the first Walsh sequence belongs and the sequence number of the first Walsh sequence;
determining the second Walsh sequence based on the seventh indication information; and
performing chip-level multiplication on the first Walsh sequence and the second Walsh sequence to obtain the third target sequence, where the sequence number of the third target sequence is equal to a modulo 2 addition of binary representations of the sequence number of the first Walsh sequence and the sequence number of the second Walsh sequence.

The second indication information is indicated by the first communication device, and may be the second indication information in the embodiment shown in FIG. 3. In some embodiments, in a case that the first communication device and the third communication device are not a same device, before determining the first Walsh sequence based on the second indication information, the third communication device may further receive the second indication information, where the second indication information is configured or indicated by the first communication device by using at least one of RRC signaling, a MAC CE, DCI, SCI, and a preamble sequence. In a case that the first communication device and the third communication device are a same device, the third communication device may directly obtain the second indication information.

In the second implementation, the third communication device may determine the third target sequence based on both the second indication information from the first communication device and the seventh indication information from the second communication device. The third target sequence is the same as the third target sequence determined in the foregoing first implementation.

It should be noted that an application scenario corresponding to the second implementation may be as follows: The second communication device generates the second signal based on the second Walsh sequence and the backscatter signal, and then indicates, to the third communication device by using the fifth indication information, the second Walsh sequence, or the dimension of the Walsh sequence group to which the second Walsh sequence belongs and the sequence number of the second Walsh sequence. The third communication device determines the first Walsh sequence based on the second indication information of the first communication device, determines the second Walsh sequence based on the fifth indication information of the second communication device, and then determines a Walsh sequence obtained by performing chip-level multiplication on the first Walsh sequence and the second Walsh sequence as the third target sequence.

In a third implementation, in a case that the seventh indication information is indicated by the fourth communication device, and the seventh indication information is used to indicate the third Walsh sequence and the fourth Walsh sequence or indicates the dimension of the Walsh sequence group to which the third Walsh sequence and the fourth Walsh sequence belong, the sequence number of the third Walsh sequence, and the sequence number of the fourth Walsh sequence, that the third communication device determines the third target sequence based on the seventh indication information may include:
determining the first Walsh sequence based on second indication information;
determining the third Walsh sequence and the fourth Walsh sequence based on the seventh indication information; and
determining the third target sequence based on the first Walsh sequence, the third Walsh sequence, and the fourth Walsh sequence, where the third target sequence meets two of the following:
the third target sequence is a Walsh sequence in the Walsh sequence group; and
a modulo 2 addition of binary representations of the sequence number of the third target sequence and the sequence number of the first Walsh sequence, the sequence number of the third Walsh sequence, and the sequence number of the fourth Walsh sequence is 0.

The second indication information is the same as the second indication information in the foregoing second implementation. Details are not described herein again. In the third implementation, the third communication device may jointly determine the third target sequence based on both the second indication information from the first communication device and the seventh indication information from the second communication device. The third target sequence belongs to a same Walsh sequence group as the first Walsh sequence, the third Walsh sequence, and the fourth Walsh sequence, and a modulo 2 addition of binary representations of the sequence number of the third target sequence and the sequence numbers of the three Walsh sequences: the first Walsh sequence, the third Walsh sequence, and the fourth Walsh sequence is 0.

It should be noted that an application scenario corresponding to the third implementation may be as follows: The second communication device generates the second signal based on the third Walsh sequence, the fourth Walsh sequence, and the backscatter signal, and then indicates, to the third communication device by using the sixth indication information, the third Walsh sequence and the fourth Walsh sequence, or the dimension of the Walsh sequence group to which the third Walsh sequence and the fourth Walsh sequence belong, the sequence number of the third Walsh sequence, and the sequence number of the fourth Walsh sequence. The third communication device determines the first Walsh sequence based on the second indication information of the first communication device, determines the third Walsh sequence and the fourth Walsh sequence based on the sixth indication information of the second communication device, and determines the third target sequence based on the first Walsh sequence, the third Walsh sequence, and the fourth Walsh sequence.

In a fourth implementation, in a case that the seventh indication information is configured or indicated by the fourth communication device, and the seventh indication information is used to indicate the third target sequence or indicates the dimension of the Walsh sequence group to which the third target sequence belongs and the sequence number of the third target sequence, when determining the third target sequence based on the seventh indication information, the third communication device may directly determine and obtain the third target sequence based on the seventh indication information.

It should be noted that the third target sequence configured or indicated by the fourth communication device needs to correspond to the first target sequence used by the second communication device. For example, in a case that the first target sequence used by the second communication device is the second Walsh sequence, the third target sequence configured or indicated by the fourth communication device may be a Walsh sequence obtained by performing chip-level multiplication on the first Walsh sequence and the second Walsh sequence, that is, the second target sequence. In a case that the first target sequence used by the second communication device is the third Walsh sequence and the fourth Walsh sequence, the third target sequence configured or indicated by the fourth communication device may be a sequence in the Walsh sequence group to which the third Walsh sequence and the fourth Walsh sequence belong, and a modulo 2 addition of binary representations of the sequence number of the third target sequence and the sequence number of the first Walsh sequence, the sequence number of the third Walsh sequence, and the sequence number of the fourth Walsh sequence is 0.

An application scenario corresponding to the fourth implementation may be as follows: The fourth communication device configures or indicates the first target sequence (the second Walsh sequence, or the third Walsh sequence and the fourth Walsh sequence) to the second communication device, and configures or indicates the third target sequence to the third communication device, where the third target sequence corresponds to the first target sequence. The second communication device generates the second signal based on the first target sequence configured or indicated by the fourth communication device and the backscatter signal, and the third communication device determines the third target sequence based on the configuration or indication of the fourth communication device.

S506. The third communication device performs spectrum de-spreading on the first signal and the second signal based on the third target sequence.

After determining the third target sequence based on any implementation in S504, the third communication device may perform spectrum de-spreading on the first signal and the second signal based on the third target sequence. For an implementation of spectrum de-spreading, refer to the implementation in a related technology. Details are not described herein.

It should be noted that, in an embodiment of this application, the first signal is obtained by performing spectrum spreading on the original signal based on the first Walsh sequence, the second signal is generated based on the second Walsh sequence and the backscatter signal, and the backscatter signal is generated by performing modulation and backscatter on the first signal, that is, the second signal is a signal generated based on the second target sequence. In this case, it can be learned based on content in the foregoing S504 that the third target sequence determined by the third communication device is the second target sequence. Because the second target sequence is a Walsh sequence obtained by performing chip-level multiplication on the first Walsh sequence and the second Walsh sequence, it can be learned based on characteristics of Walsh sequences that the second target sequence is orthogonal to the first Walsh sequence and is not orthogonal to the second target sequence. Therefore, when spectrum de-spreading is performed on the first signal and the second signal based on the third target sequence, for the first signal, the first signal may be eliminated by using a characteristic that the second target sequence is orthogonal to the first Walsh sequence in the first signal, so as to eliminate an interference signal. For the second signal, the backscatter signal in the second signal may be recovered by using a characteristic that the second target sequence is not orthogonal to the second target sequence in the second signal, so as to obtain a useful signal.

In another embodiment of this application, the first signal is obtained by performing spectrum spreading on the original signal based on the first Walsh sequence, the second signal is generated based on the third Walsh sequence, the fourth Walsh sequence, and the backscatter signal, and the backscatter signal is generated by performing modulation and backscatter on the first signal, that is, the second signal is a signal generated based on the fourth target sequence. The fourth target sequence is a Walsh sequence obtained by performing equal-amplitude superposition and mapping processing on the first Walsh sequence, the third Walsh sequence, and the fourth Walsh sequence. In this case, it can be learned from the content in the foregoing S504 that the third target sequence determined by the third communication device belongs to a same Walsh sequence group as the first Walsh sequence, the third Walsh sequence, and the fourth Walsh sequence, and a modulo 2 addition of binary representations of the sequence number of the third target sequence and the sequence numbers of the three Walsh sequences: the first Walsh sequence, the third Walsh sequence, and the fourth Walsh sequence is 0. It can be learned based on characteristics of Walsh sequences that the third target sequence is orthogonal to the first Walsh sequence, and is not orthogonal to the fourth target sequence. Therefore, when spectrum de-spreading is performed on the first signal and the second signal based on the third target sequence, for the first signal, the first signal may be eliminated by using a characteristic that the second target sequence is orthogonal to the first Walsh sequence in the first signal, so as to eliminate an interference signal. For the second signal, the backscatter signal in the second signal may be recovered by using a characteristic that the third target sequence is not orthogonal to the fourth target sequence in the second signal, so as to obtain a useful signal.

In this embodiment of this application, when transmitting a signal to a second communication device, a first communication device may perform spectrum spreading on an original signal based on an indicated Walsh sequence to obtain a first signal, and send the first signal to the second communication device. When transmitting a backscatter signal to a third communication device, the second communication device may generate a second signal based on the backscatter signal and an indicated first target sequence, and send the second signal to the third communication device. After receiving the first signal and the second signal, the third communication device may perform spectrum de-spreading on the first signal and the second signal based on an indicated third target sequence. Both the first signal and the second signal are signals processed by using Walsh sequences. Therefore, when performing spectrum de-spreading on the first signal and the second signal based on the Walsh sequence, the third communication device may eliminate an interference signal and recover a useful backscatter signal based on characteristics of the Walsh sequence, so as to effectively eliminate the interference signal, thereby ensuring communication performance of backscatter communication and improving transmission efficiency, a transmission distance, and transmission reliability of backscatter communication.

As shown in FIG. 6, an embodiment of this application provides a signal processing method 600. The method may be performed by a fourth communication device. The fourth communication device may be the radio frequency source 21, the backscatter communication receiving device 23, the backscatter communication transmitting device 21 shown in FIG. 2, or a third-party network device. The third-party network device may be a terminal or a network side device in the embodiment shown in FIG. 1. In other words, the signal processing method may be performed by software or hardware installed in the radio frequency source, the backscatter communication receiving device, the backscatter communication transmitting device, or the third-party network device. The signal processing method includes the following steps.

S602. The fourth communication device configures or indicates at least one of a first Walsh sequence, a first target sequence, and a third target sequence, or at least one of a dimension of a Walsh sequence group, a sequence number of the first Walsh sequence, a sequence number of the first target sequence, and a sequence number of the third target sequence to a first communication device, a second communication device, and a third communication device.

The fourth communication device may be the first communication device, the second communication device, the third communication device, or a third-party network device. The first communication device may be a radio frequency source, the second communication device may be a backscatter communication transmitting device, the third communication device may be a backscatter communication receiving device, and the third-party network device may be another device other than the radio frequency source, the backscatter communication transmitting device, and the backscatter communication receiving device, for example, may be a base station, a relay device, a reader device, or another terminal device. In this embodiment of this application, the fourth communication device may uniformly configure or indicate at least one of the first Walsh sequence, the first target sequence, and the third target sequence, or at least one of the dimension of the Walsh sequence group, the sequence number of the first Walsh sequence, the sequence number of the first target sequence, and the sequence number of the third target sequence to the first communication device, the second communication device, and the third communication device in a static or semi-static manner. Both the first target sequence and the third target sequence are Walsh sequences.

In an embodiment, the fourth communication device may configure or indicate the first Walsh sequence, or the dimension of the Walsh sequence group and the sequence number of the first Walsh sequence to the first communication device, configure or indicate the first target sequence, or the dimension of the Walsh sequence group and the sequence number of the first target sequence to the second communication device, or configure or indicate the third target sequence, or the dimension of the Walsh sequence group and the sequence number of the third target sequence to the third communication device. The first Walsh sequence may be used by the first communication device to perform spectrum spreading on an original signal to generate a first signal, the first target sequence may be used by the second communication device to generate a second signal based on a backscatter modulation signal, the backscatter modulation signal is generated after the second communication device performs modulation and backscatter on the first signal, and the third target sequence may be used by the third communication device to perform spectrum de-spreading on the first signal and the second signal. For detailed descriptions of the first Walsh sequence, the first target sequence, and the third target sequence, refer to the corresponding content in the embodiments shown in FIG. 3 to FIG. 5. For implementation of generating the first signal by the first communication device based on the first Walsh sequence indicated by the fourth communication device, refer to the embodiment shown in FIG. 3. For implementation of generating the second signal by the second communication device based on the first target sequence indicated by the fourth communication device, refer to the embodiment shown in FIG. 4. For implementation of performing, by the third communication device, spectrum de-spreading based on the third target sequence indicated by the fourth communication device, refer to the embodiment shown in FIG. 5. Details are not described in detail herein again.

It should be noted that, in another implementation, the Walsh sequence configured by the fourth communication device to the first communication device to the third communication device may be another combination. For example, the fourth communication device may configure or indicate the first Walsh sequence, or the dimension of the Walsh sequence group and the sequence number of the first Walsh sequence to the first communication device, or configure or indicate the first target sequence, or the dimension of the Walsh sequence group and the sequence number of the first target sequence to the second communication device, or configure or indicate the first Walsh sequence and the second target sequence, or the dimension of the Walsh sequence group, the sequence number of the first Walsh sequence, and the sequence number of the first target sequence to the third communication device, and the third communication device may determine the third target sequence based on the configuration or indication of the fourth communication device. No examples are provided one by one herein.

In an embodiment, a configuration or indication manner of the fourth communication device includes at least one of the following:

RRC signaling, a MAC CE, DCI, SCI, and a preamble sequence.

In an embodiment, the fourth communication device may configure or indicate a use manner of the first target sequence to the second communication device. The use manner includes a first manner or a second manner. The first manner represents a manner of performing chip-level multiplication on the first target sequence and the first Walsh sequence based on a multiplication principle, and the second manner represents a manner of performing equal-amplitude superposition and mapping processing on the first target sequence and the first Walsh sequence based on an equal-amplitude superposition principle. For example, the fourth communication device may configure or indicate the use manner of the first target sequence to the second communication device by using the fourth indication information, and the second communication device may use the first target sequence based on the indication of the fourth communication device. For an implementation, refer to the corresponding content in the embodiment shown in FIG. 4. Details are not described herein again.

In an embodiment, the fourth communication device may further configure or indicate a generation manner of the third target sequence to the third communication device. The generation manner may include: generating the third target sequence through chip-level multiplication based on the multiplication principle or generating the third target sequence through equal-amplitude superposition and mapping processing based on the equal-amplitude superposition principle. For example, the fourth communication device configures or indicates the first Walsh sequence and the first target sequence to the third communication device, and further configures or indicates the generation manner of the third target sequence. In this case, the third communication device may generate the third target sequence based on the first Walsh sequence and the first target sequence and based on the generation manner.

In an embodiment, the fourth communication device may configure or indicate the use manner of the first target sequence or the generation manner of the third target sequence by using at least one of the following:

RRC signaling, a MAC CE, DCI, SCI, and a physical frame preamble.

In this embodiment of this application, a fourth communication device may uniformly configure or indicate Walsh sequences respectively used by a first communication device, a second communication device, and a third communication device. When transmitting a signal to the second communication device, the first communication device may perform spectrum spreading on an original signal based on an indicated Walsh sequence to obtain a first signal, and send the first signal to the second communication device. When transmitting a backscatter signal to the third communication device, the second communication device may generate a second signal based on the backscatter signal and an indicated first target sequence, and send the second signal to the third communication device. After receiving the first signal and the second signal, the third communication device may perform spectrum de-spreading on the first signal and the second signal based on an indicated third target sequence. Both the first signal and the second signal are signals processed by using Walsh sequences. Therefore, when performing spectrum de-spreading on the first signal and the second signal based on the Walsh sequence, the third communication device may eliminate an interference signal and recover a useful backscatter signal based on characteristics of the Walsh sequence, so as to effectively eliminate the interference signal, thereby ensuring communication performance of backscatter communication and improving transmission efficiency, a transmission distance, and transmission reliability of backscatter communication.

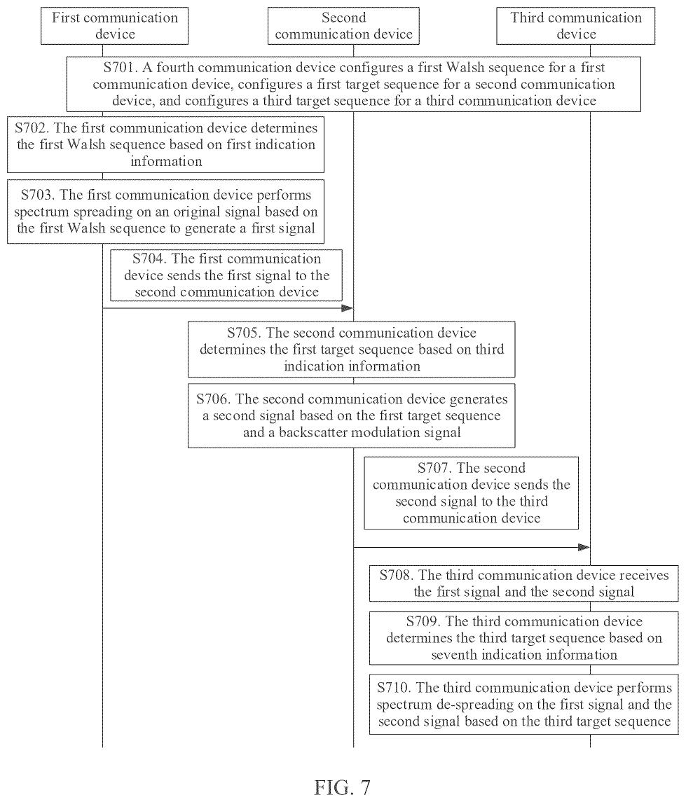

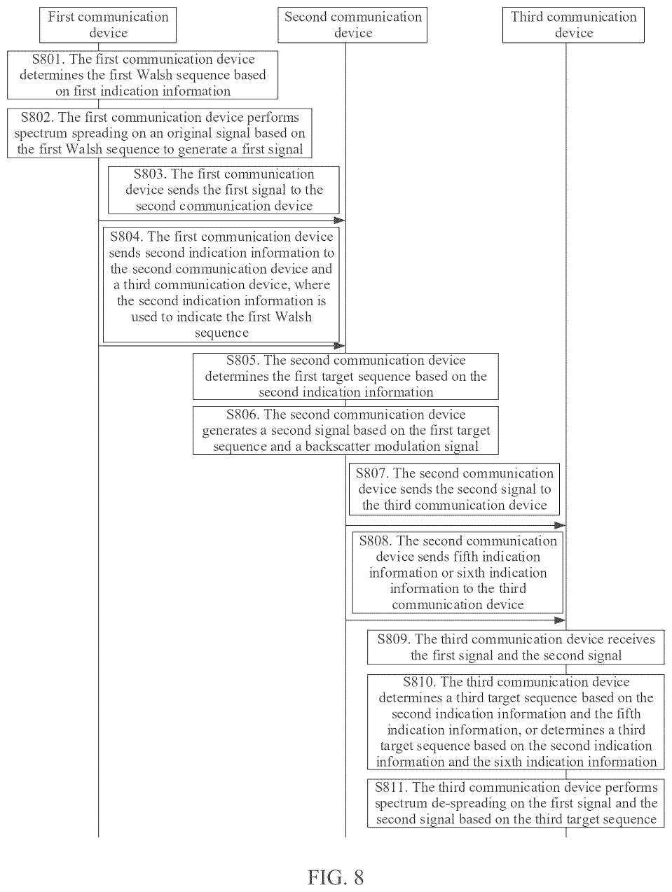

In the technical solution provided in this embodiment of this application, the Walsh sequences respectively used by the first communication device, the second communication device, and the third communication device may be configured or indicated in a static or semi-static manner, or may be indicated in a dynamic manner. For ease of understanding, refer to FIG. 7 and FIG. 8.

FIG. 7 is a schematic flowchart of a signal processing method according to an embodiment of this application. In the embodiment shown in FIG. 7, the Walsh sequences respectively used by the first communication device, the second communication device, and the third communication device may be configured or indicated in a static semi-static manner, which may include the following steps.

S701. A fourth communication device configures a first Walsh sequence for a first communication device, configures a first target sequence for a second communication device, and configures a third target sequence for a third communication device.

The fourth communication device may be the first communication device, the second communication device, the third communication device, or a third-party network device. The fourth communication device may configure the first Walsh sequence for the first communication device by using first indication information, configure the first target sequence for the second communication device by using third indication information, and configure the third target sequence for the third communication device by using seventh indication information.

In some embodiments, the fourth communication device may further configure or indicate, to the first communication device, a dimension of a Walsh sequence group to which the first Walsh sequence belongs and a sequence number of the first Walsh sequence, configure, for the second communication device, a dimension of a Walsh sequence group to which the first target sequence belongs and a sequence number of the first target sequence, and configure, for the third communication device, a dimension of a Walsh sequence group to which the third target sequence belongs and a sequence number of the third target sequence. An example in which only a Walsh sequence is configured or indicated is used for description herein.

S702. The first communication device determines the first Walsh sequence based on first indication information.

S703. The first communication device performs spectrum spreading on an original signal based on the first Walsh sequence to generate a first signal.

S704. The first communication device sends the first signal to the second communication device.

S705. The second communication device determines the first target sequence based on third indication information.

S706. The second communication device generates a second signal based on the first target sequence and a backscatter modulation signal.

The backscatter modulation signal is generated after the second communication device performs modulation and backscatter on the first signal.

S707. The second communication device sends the second signal to the third communication device.

S708. The third communication device receives the first signal and the second signal.

S709. The third communication device determines the third target sequence based on seventh indication information.

S710. The third communication device performs spectrum de-spreading on the first signal and the second signal based on the third target sequence.

For an implementation of the foregoing S701 to S710, refer to the implementation of the corresponding steps in the embodiments shown in FIG. 3 to FIG. 6. Details are not described herein again.

FIG. 8 is a schematic flowchart of a signal processing method according to an embodiment of this application. In the embodiment shown in FIG. 8, the Walsh sequences respectively used by the first communication device, the second communication device, and the third communication device may be indicated in a dynamic manner, which may include the following steps.

S801. A first communication device determines a first Walsh sequence based on first indication information.

The first indication information may be indicated by a fourth communication device, and the fourth communication device may be the first communication device, a second communication device, a third communication device, or a third-party network device.

S802. The first communication device performs spectrum spreading on an original signal based on the first Walsh sequence to generate a first signal.

S803. The first communication device sends the first signal to a second communication device.

S804. The first communication device sends second indication information to the second communication device and a third communication device, where the second indication information is used to indicate the first Walsh sequence.

In some embodiments, the second indication information may be further used to indicate a dimension of a Walsh sequence group to which the first Walsh sequence belongs and a sequence number of the first Walsh sequence. An example in which only the first Walsh sequence is indicated is used for description herein.

It should be noted that in a case that the first communication device and the third communication device are a same device (a monostatic backscatter communication architecture), the first communication device may not need to send the second indication information to the third communication device. Herein, only an example in which the first communication device and the third communication device are not a same device is used for description.

S805. The second communication device determines the first target sequence based on the second indication information.

For example, the second communication device may determine a use manner of the first target sequence based on fourth indication information, and then determine the first target sequence based on the second indication information and the use manner of the first target sequence. For an implementation, refer to the corresponding content in the embodiment shown in FIG. 3. Details are not described herein again.

S806. The second communication device generates a second signal based on the first target sequence and a backscatter modulation signal.

The backscatter modulation signal is generated after the second communication device performs modulation and backscatter on the first signal.

S807. The second communication device sends the second signal to the third communication device.

S808. The second communication device sends fifth indication information or sixth indication information to the third communication device.

In a case that the first target sequence is a second Walsh sequence, the second communication device may send the fifth indication information to the third communication device. The fifth indication information is used to indicate any one of the following:
the second Walsh sequence, or a dimension of a Walsh sequence group to which the second Walsh sequence belongs and a sequence number of the second Walsh sequence; and
a second target sequence, or a dimension of a Walsh sequence group to which the second target sequence belongs and a sequence number of the second target sequence, where the sequence number of the second target sequence is equal to a modulo 2 addition of binary representations of the sequence number of the first Walsh sequence and the sequence number of the second Walsh sequence.

In a case that the first target sequence is a third Walsh sequence and a fourth Walsh sequence, the second communication device may send the sixth indication information to the third communication device, where the sixth indication information is used to indicate the third Walsh sequence and the fourth Walsh sequence, or a dimension of a Walsh sequence group to which the third Walsh sequence and the fourth Walsh sequence belong, a sequence number of the third Walsh sequence, and a sequence number of the fourth Walsh sequence.

S809. The third communication device receives the first signal and the second signal.

S810. The third communication device determines a third target sequence based on the second indication information and the fifth indication information, or determines a third target sequence based on the second indication information and the sixth indication information.

S811. The third communication device performs spectrum de-spreading on the first signal and the second signal based on the third target sequence.

For an implementation of the foregoing S801 to S811, refer to the implementation of the corresponding steps in the embodiments shown in FIG. 3 to FIG. 6. Details are not described herein again.

To facilitate understanding of the technical solutions provided in the embodiments of this application, the following separately uses a monostatic backscatter communication architecture and a bistatic backscatter communication architecture as examples for description.

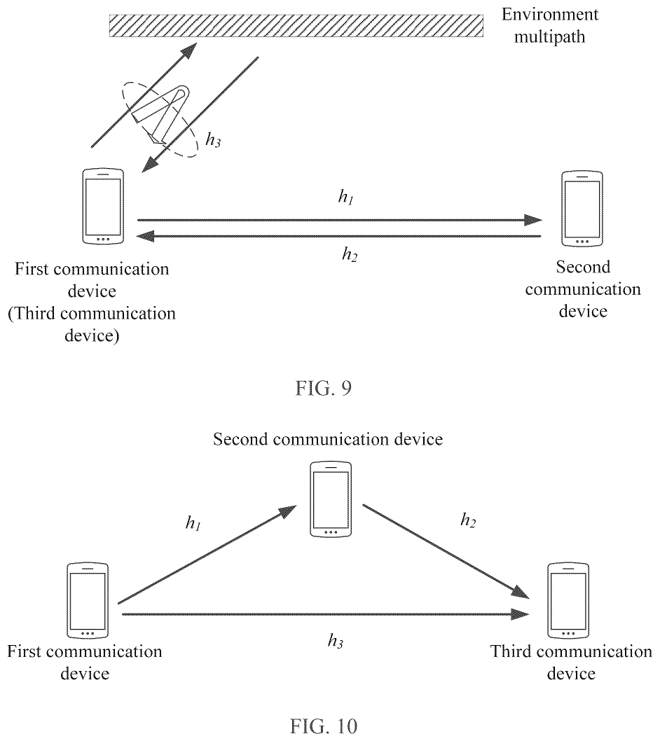

FIG. 9 is a schematic diagram of a signal processing method according to an embodiment of this application. A backscatter communication system shown in FIG. 9 is a monostatic backscatter communication architecture. In FIG. 9, a case that a fourth communication device uniformly configures or indicates a Walsh sequence to a first communication device, a second communication device, and a third communication device is used as an example for description.

In FIG. 9, when transmitting a signal to the second communication device, the first communication device may perform, by using a first Walsh sequence cₐ(k) configured or indicated by the fourth communication device, spectrum spreading on an original signal to generate a first signal, where the first signal may be denoted as:

$$s ( ⌊ \frac{k}{M} ⌋ ) = x ( ⌊ \frac{k}{M} ⌋ ) {c}_{a} ( k ) , \qquad ( 1 )$$

where
cₐ(k) is a Walsh sequence of a length M.

After generating the first signal, the first communication device may send the first signal to the second communication device.

After the second communication device receives the first signal, the received first signal may be denoted as:

$$u ( k ) = {h}_{1} ( ⌊ \frac{k}{M} ⌋ ) x ( ⌊ \frac{k}{M} ⌋ ) {c}_{a} ( k ) + {n}_{1} ( k ) \qquad ( 2 )$$

where
h₁ represents a channel between the second communication device and the first communication device, and n₁(k) is a noise signal.

The second communication device performs modulation and backscatter on the received signal by using a baseband signal b (n) to generate a backscatter signal, and then generates a second signal based on a first target sequence configured or indicated by the fourth communication device and the backscatter signal, where the second signal may be denoted as:

$$v ( k ) = b ( ⌊ \frac{k}{M} ⌋ ) {h}_{1} ( ⌊ \frac{k}{M} ⌋ ) x ( ⌊ \frac{k}{M} ⌋ ) {c}_{m} ( k ) + {n}_{2} ( k ) , \qquad ( 3 )$$

where
in a case that the first target sequence is a second Walsh sequence c_{b}(k) (a Walsh sequence of a length M, belonging to a same Walsh sequence group as the first Walsh sequence but different from the first Walsh sequence), cₘ(k) may be denoted as:

$${c}_{m} ( k ) = {c}_{a} ( k ) \cdot {c}_{b} ( k ) , m = a ⊕ b , \qquad ( 4 )$$

where
in a case that the first target sequence is a third Walsh sequence c_{c}(k) and a fourth Walsh sequence c_{d}(k) (both are Walsh sequences of a length M, belonging to a same Walsh sequence group as the first Walsh sequence but different from the first Walsh sequence), cₘ(k) may meet the following condition:

$$\{ \begin{matrix}{c}_{m} ( k ) = \frac{{c}_{f} ( k )}{3} , if {c}_{f} ( k ) = \pm 3 \\ {c}_{m} ( k ) = 0 , if {c}_{f} ( k ) = \pm 1\end{matrix} \qquad ( 5 )$$

$$or$$

$$\{ \begin{matrix}{c}_{m} ( k ) = 0 , if {c}_{f} ( k ) = \pm 3 \\ {c}_{m} ( k ) = {c}_{f} ( k ) , if {c}_{f} ( k ) = \pm 1\end{matrix} , \qquad ( 6 )$$

where:

$${c}_{f} ( k ) = {c}_{a} ( k ) + {c}_{c} ( k ) + {c}_{d} ( k ) , {c}_{f} ( k ) ∈ \{ \pm 1 , \pm 3 \} \qquad ( 7 )$$

After generating the second signal, the second communication device may send the second signal to the third communication device.

When receiving a signal, the third communication device (that is, the first communication device) may receive the first signal and the second signal, and the received signal may be denoted as:

$$y ( k ) = {h}_{3} ( ⌊ \frac{k}{M} ⌋ ) x ( ⌊ \frac{k}{M} ⌋ ) {c}_{a} ( k ) + {h}_{2} ( ⌊ \frac{k}{M} ⌋ ) b ( ⌊ \frac{k}{M} ⌋ ) {h}_{1} ( ⌊ \frac{k}{M} ⌋ ) x ( ⌊ \frac{k}{M} ⌋ ) {c}_{m} ( k ) + {n}_{3} ( k ) \qquad ( 8 )$$

The first item of the foregoing signal includes a self-interference signal caused by a carrier leakage and includes a multipath interference signal caused by an environment multipath, the second item is a signal item that is received by the third communication device and that is attenuated by a two-way link and for modulating a backscatter signal, h₃ represents a channel between reception and transmission of the third communication device, and h₂ represents a channel between the second communication device and the third communication device.

After receiving the first signal and the second signal, the third communication device may perform spectrum de-spreading on the first signal based on a third target sequence configured or indicated by the fourth communication device.

For example, in a case that the third target sequence configured or indicated by the fourth communication device is a Walsh sequence obtained by performing chip-level multiplication on the first Walsh sequence and the second Walsh sequence, that is, a second target sequence (in this case, the first target sequence used by the second communication device is the second Walsh sequence), the third target sequence may be denoted as:

$${c}_{n} ( k ) = {c}_{m} ( k ) , n = m \qquad ( 9 )$$

It can be learned from characteristics of the Walsh sequence that the third target sequence is orthogonal to cₐ(k) in the first item of the signal received by the third communication device, and is not orthogonal to cₘ(k) in the second item. Therefore, when spectrum de-spreading is performed on the received first signal and the received second signal based on the third target sequence, the first item may be eliminated, and the second item may be reserved, so that an interference signal can be eliminated and a useful signal can be recovered.

In a case that the third target sequence configured or indicated by the fourth communication device belongs to a same Walsh sequence group as the first Walsh sequence, the third Walsh sequence, and the fourth Walsh sequence, and a modulo 2 addition of binary representations of a sequence number of the third target sequence, a sequence number of the first Walsh sequence, a sequence number of the third Walsh sequence, and a sequence number of the fourth Walsh sequence is 0 (in this case, the first target sequence used by the second communication device is the third Walsh sequence and the fourth Walsh sequence), the third target sequence may be denoted as:

$${c}_{n} ( k ) , n ⊕ a ⊕ c ⊕ d = 0 \qquad ( 10 )$$

It can be learned from characteristics of the Walsh sequence that the third target sequence is orthogonal to cₐ(k) in the first item of the signal received by the third communication device, and is not orthogonal to cₘ(k) in the second item. Therefore, when spectrum de-spreading is performed on the received first signal and the received second signal based on the third target sequence, the first item may be eliminated, and the second item may be reserved, so that an interference signal can be eliminated and a useful signal can be recovered.

FIG. 10 is a schematic diagram of a signal processing method according to an embodiment of this application. A backscatter communication system shown in FIG. 9 is a bistatic backscatter communication architecture. FIG. 10 is described by using an example in which the Walsh sequences respectively used by the first communication device, the second communication device, and the third communication device are dynamically indicated.

In FIG. 10, when transmitting a signal to the second communication device, the first communication device may independently select a first Walsh sequence cₐ(k) based on first indication information to perform spectrum spreading on an original signal to generate a first signal, where the first signal may be denoted as:

$$s ( ⌊ \frac{k}{M} ⌋ ) = x ( ⌊ \frac{k}{M} ⌋ ) {c}_{a} ( k ) , \qquad ( 11 )$$

where
cₐ(k) is a Walsh sequence of a length M.

After generating the first signal, the first communication device may send the first signal to the second communication device, and send second indication information to the second communication device and the third communication device, where the second indication information is used to indicate the first Walsh sequence, or a dimension of a Walsh sequence group to which the first Walsh sequence belongs and a sequence number of the first Walsh sequence.

After the second communication device receives the first signal, the received first signal may be denoted as:

$$u ( k ) = {h}_{1} ( ⌊ \frac{k}{M} ⌋ ) x ( ⌊ \frac{k}{M} ⌋ ) {c}_{a} ( k ) + {n}_{1} ( k ) , \qquad ( 12 )$$

where
h₁ represents a channel between the second communication device and the first communication device, and n₁(k) is a noise signal.

The second communication device performs modulation and backscatter on the received signal by using a baseband signal b(n) to generate a backscatter signal, determines a first target sequence based on the second indication information, and generates a second signal based on the first target sequence and the backscatter signal, where the second signal may be denoted as:

$$v ( k ) = b ( ⌊ \frac{k}{M} ⌋ ) {h}_{1} ( ⌊ \frac{k}{M} ⌋ ) x ( ⌊ \frac{k}{M} ⌋ ) {c}_{m} ( k ) + {n}_{2} ( k ) \qquad ( 13 )$$

For an implementation in which the second communication device determines the first target sequence based on the second indication information, refer to the embodiment shown in FIG. 3. Details are not described herein again.

In a case that the first target sequence determined by the second communication device is a second Walsh sequence c_{b}(k) (a Walsh sequence of a length M, belonging to a same Walsh sequence group as the first Walsh sequence but different from the first Walsh sequence), cₘ(k) may be denoted as:

$${c}_{m} ( k ) = {c}_{a} ( k ) \cdot {c}_{b} ( k ) , m = a ⊕ b \qquad ( 14 )$$

In a case that the first target sequence determined by the second communication device is a third Walsh sequence c_{c}(k) and a fourth Walsh sequence c_{d}(k) (both are Walsh sequences of a length M, belonging to a same Walsh sequence group as the first Walsh sequence but different from the first Walsh sequence), cₘ(k) may meet the following condition:

$$\{ \begin{matrix}{c}_{m} ( k ) = \frac{{c}_{f} ( k )}{3} , if {c}_{f} ( k ) = \pm 3 \\ {c}_{m} ( k ) = 0 , if {c}_{f} ( k ) = \pm 1\end{matrix} \qquad ( 15 )$$

$$or$$

$$\{ \begin{matrix}{c}_{m} ( k ) = 0 , if {c}_{f} ( k ) = k 3 \\ {c}_{m} ( k ) = {c}_{f} ( k ) , if {c}_{f} ( k ) = \pm 1\end{matrix} \qquad ( 16 )$$

$$where :$$

$${c}_{f} ( k ) = {c}_{a} ( k ) + {c}_{c} ( k ) + {c}_{d} ( k ) , {c}_{f} ( k ) ∈ \{ \pm 1 , \pm 3 \} \qquad ( 17 )$$

After generating the second signal, the second communication device may send the second signal to the third communication device. In a case that the first target sequence is the second Walsh sequence, fifth indication information may be sent to the third communication device, and the fifth indication information is used to indicate any one of the following:
the second Walsh sequence, or a dimension of a Walsh sequence group to which the second Walsh sequence belongs and a sequence number of the second Walsh sequence; and
a second target sequence, or a dimension of a Walsh sequence group to which the second target sequence belongs and a sequence number of the second target sequence, where the sequence number of the second target sequence is equal to a modulo 2 addition of binary representations of the sequence number of the first Walsh sequence and the sequence number of the second Walsh sequence.

In a case that the first target sequence is a third Walsh sequence and a fourth Walsh sequence, sixth indication information may be sent to the third communication device, and the sixth indication information is used to indicate the third Walsh sequence and the fourth Walsh sequence, or a dimension of a Walsh sequence group to which the third Walsh sequence and the fourth Walsh sequence belong, a sequence number of the third Walsh sequence, and a sequence number of the fourth Walsh sequence.

When receiving a signal, the third communication device may receive the first signal and the second signal, and the received signal may be denoted as:

$$y ( k ) = {h}_{3} ( ⌊ \frac{k}{M} ⌋ ) x ( ⌊ \frac{k}{M} ⌋ ) {c}_{a} ( k ) + {h}_{2} ( ⌊ \frac{k}{M} ⌋ ) b ( ⌊ \frac{k}{M} ⌋ ) {h}_{1} ( ⌊ \frac{k}{M} ⌋ ) x ( ⌊ \frac{k}{M} ⌋ ) {c}_{m} ( k ) + {n}_{3} ( k ) \qquad ( 18 )$$

The first term of the foregoing signal is cross-link interference or direct link interference, the second term is a signal term of a backscatter signal of a cascading channel and received by the third communication device, h₃ represents a channel between the third communication device and the first communication device, and h₂ represents a channel between the second communication device and the third communication device.

After receiving the first signal and the second signal, the third communication device may determine the third target sequence based on the second indication information and the fifth indication information, or determine the third target sequence based on the second indication information and the sixth indication information. For an implementation, refer to the corresponding content in the embodiment shown in FIG. 4. Details are not described herein again. After the third target sequence is determined, spectrum de-spreading may be performed on the first signal and the second signal based on the third target sequence.

For example, in a case that the first target sequence used by the second communication device is the second Walsh sequence, the third target sequence determined by the third communication device is a Walsh sequence obtained by performing chip-level multiplication on the first Walsh sequence and the second Walsh sequence, that is, the second target sequence. In this case, the third target sequence may be denoted as:

$${c}_{n} ( k ) = {c}_{m} ( k ) , n = m \qquad ( 19 )$$

It can be learned from characteristics of the Walsh sequence that the third target sequence is orthogonal to cₐ(k) in the first item of the signal received by the third communication device, and is not orthogonal to cₘ(k) in the second item. Therefore, when spectrum de-spreading is performed on the received first signal and the received second signal based on the third target sequence, the first item may be eliminated, and the second item may be reserved, so that an interference signal can be eliminated and a useful signal can be recovered.

In a case that the first target sequence used by the second communication device is the third Walsh sequence and the fourth Walsh sequence, the third target sequence determined by the third communication device belongs to a same Walsh sequence group as the first Walsh sequence, the third Walsh sequence, and the fourth Walsh sequence, and a modulo 2 addition of binary representations of a sequence number of the third target sequence, a sequence number of the first Walsh sequence, a sequence number of the third Walsh sequence, and a sequence number of the fourth Walsh sequence is 0. In this case, the third target sequence may be denoted as:

$${c}_{n} ( k ) , n ⊕ a ⊕ c ⊕ d = 0 \qquad ( 20 )$$

It can be learned from characteristics of the Walsh sequence that the third target sequence is orthogonal to cₐ(k) in the first item of the signal received by the third communication device, and is not orthogonal to cₘ(k) in the second item. Therefore, when spectrum de-spreading is performed on the received first signal and the received second signal based on the third target sequence, the first item may be eliminated, and the second item may be reserved, so that an interference signal can be eliminated and a useful signal can be recovered.

In this embodiment of this application, when transmitting a signal to a second communication device, a first communication device may perform spectrum spreading on an original signal based on an indicated Walsh sequence to obtain a first signal, and send the first signal to the second communication device. When transmitting a backscatter signal to a third communication device, the second communication device may generate a second signal based on the backscatter signal and an indicated first target sequence, and send the second signal to the third communication device. After receiving the first signal and the second signal, the third communication device may perform spectrum de-spreading on the first signal and the second signal based on an indicated third target sequence. Both the first signal and the second signal are signals processed by using Walsh sequences. Therefore, when performing spectrum de-spreading on the first signal and the second signal based on the Walsh sequence, the third communication device may eliminate an interference signal and recover a useful backscatter signal based on characteristics of the Walsh sequence, so as to effectively eliminate the interference signal, thereby ensuring communication performance of backscatter communication and improving transmission efficiency, a transmission distance, and transmission reliability of backscatter communication.

The signal processing method provided in the embodiments of this application may be performed by a signal processing apparatus. In the embodiments of this application, an example in which the signal processing apparatus performs the signal processing method is used to describe the signal processing apparatus provided in the embodiments of this application.

FIG. 11 is a schematic structural diagram of a signal processing apparatus according to an embodiment of this application. The apparatus may correspond to a first communication device in another embodiment. As shown in FIG. 11, the apparatus 1100 includes the following modules:
a determining module 1101, configured to determine a first Walsh sequence based on first indication information;
a signal processing module 1102, configured to perform spectrum spreading on an original signal based on the first Walsh sequence to generate a first signal; and
a transmitting module 1103, configured to send the first signal to a second communication device, where the apparatus is a device that provides a radio frequency carrier source for the second communication device.

In an embodiment, the first indication information is used to indicate the first Walsh sequence or indicate a dimension of a Walsh sequence group to which the first Walsh sequence belongs and a sequence number of the first Walsh sequence.

In an embodiment, the first indication information is configured or indicated by a fourth communication device, and the fourth communication device is the first communication device, the second communication device, a third communication device, or a third-party network device.

In an embodiment, the apparatus further includes a receiving module, and in a case that the first indication information is configured or indicated by the fourth communication device and the fourth communication device is different from the first communication device, the receiving module is configured to:
receive the first indication information, where
the first indication information is configured or indicated by the fourth communication device by using at least one of radio resource control RRC signaling, a medium access control control element MAC CE, downlink control information DCI, sidelink control information SCI, and a preamble sequence.

In an embodiment, the transmitting module is further configured to:
send second indication information to the second communication device and the third communication device in a case that the first communication device and the third communication device are different devices; and
send the second indication information to the second communication device in a case that the first communication device and the third communication device are a same device, where
the second indication information is used to indicate the first Walsh sequence or indicate a dimension of a Walsh sequence group to which the first Walsh sequence belongs and a sequence number of the first Walsh sequence.

In an embodiment, the transmitting module 1103 is configured to:
send the second indication information by using at least one of RRC signaling, a MAC CE, DCI, SCI, and a preamble sequence.

The apparatus 1100 in this embodiment of this application may refer to the procedure corresponding to the method 300 in the embodiments of this application. In addition, the units/modules in the apparatus 1100 and the foregoing other operations and/or functions are respectively used to implement the corresponding procedure in the method 300, and a same or equivalent technical effect can be achieved. For brevity, details are not described herein again.

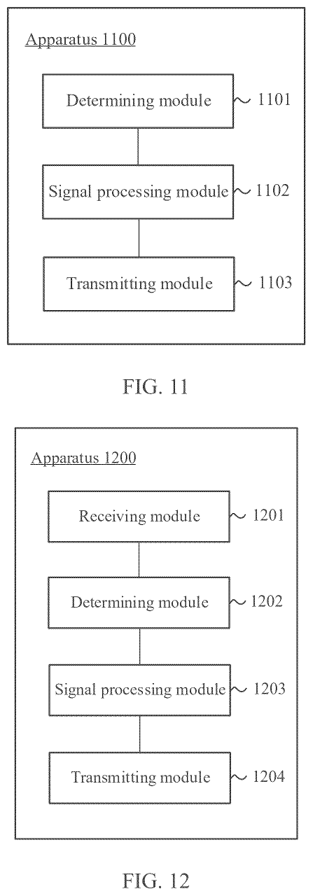

FIG. 12 is a schematic structural diagram of a signal processing apparatus according to an embodiment of this application. The apparatus may correspond to a second communication device in another embodiment. As shown in FIG. 12, the apparatus 1200 includes the following modules:
a receiving module 1201, configured to receive a first signal, where the first signal is generated after a first communication device performs spectrum spreading on an original signal based on a first Walsh sequence;
a determining module 1202, configured to determine a first target sequence based on third indication information;
a signal processing module 1203, configured to generate a second signal based on the first target sequence and a backscatter modulation signal, where the backscatter modulation signal is generated by performing modulation and backscatter on the first signal; and
a transmitting module 1204, configured to send the second signal to a third communication device.

In an embodiment, the third indication information is indicated by the first communication device, and the third indication information is used to indicate the first Walsh sequence or indicate a dimension of a Walsh sequence group to which the first Walsh sequence belongs and a sequence number of the first Walsh sequence; or
the third indication information is configured or indicated by a fourth communication device, the fourth communication device is the first communication device, the second communication device, the third communication device, or a third-party network device, and the third indication information is used to indicate any one of the following:
a second Walsh sequence in the Walsh sequence group, or the dimension of the Walsh sequence group and a sequence number of the second Walsh sequence, where the second Walsh sequence is different from the first Walsh sequence; and
a third Walsh sequence and a fourth Walsh sequence in the Walsh sequence group, or the dimension of the Walsh sequence group, a sequence number of the third Walsh sequence, and a sequence number of the fourth Walsh sequence, where the third Walsh sequence, the fourth Walsh sequence, and the first Walsh sequence are different from each other.

In an embodiment, in a case that the third indication information is indicated by the first communication device, or in a case that the third indication information is configured or indicated by the fourth communication device and the fourth communication device is not the second communication device, the receiving module 1201 is further configured to:
receive the third indication information, where
the third indication information is configured or indicated by using at least one of RRC signaling, a MAC CE, DCI, SCI, and a preamble sequence.

In some embodiments, in a case that the third indication information is used to indicate the first Walsh sequence or indicate the dimension of the Walsh sequence group to which the first Walsh sequence belongs and the sequence number of the first Walsh sequence, the determining module 1202 is configured to:
determine the first Walsh sequence based on the third indication information;
determine a use manner of the first target sequence based on fourth indication information, where the use manner includes a first manner or a second manner, the first manner represents a manner of performing chip-level multiplication on the first target sequence and the first Walsh sequence based on a multiplication principle, and the second manner represents a manner of performing equal-amplitude superposition and mapping processing on the first target sequence and the first Walsh sequence based on an equal-amplitude superposition principle; and
determine the first target sequence based on the first Walsh sequence and the use manner.

In an embodiment, the fourth indication information is configured or indicated by a fourth communication device, and the fourth communication device is the first communication device, the second communication device, the third communication device, or a third-party network device; and
in a case that the fourth communication device is not the second communication device, the receiving module 1201 is further configured to:
receive the fourth indication information, where the fourth indication information is configured or indicated by using at least one of RRC signaling, a MAC CE, DCI, SCI, and a preamble sequence.

In an embodiment, the determining module 1202 is configured to:
in a case that the use manner is the first manner, determine the second Walsh sequence based on the first Walsh sequence, and determine the second Walsh sequence as the first target sequence; and
in a case that the use manner is the second manner, determine the third Walsh sequence and the fourth Walsh sequence based on the first Walsh sequence, and determine the third Walsh sequence and the fourth Walsh sequence as the first target sequence.

In an embodiment, the transmitting module 1204 is further configured to:
send fifth indication information to the third communication device in a case that the use manner is the first manner, where the fifth indication information is used to indicate any one of the following:
the second Walsh sequence, or the dimension of the Walsh sequence group to which the second Walsh sequence belongs and the sequence number of the second Walsh sequence; and
a second target sequence, or the dimension of the Walsh sequence group and a sequence number of the second target sequence, where the sequence number of the second target sequence is equal to a modulo 2 addition of binary representations of the sequence number of the first Walsh sequence and the sequence number of the second Walsh sequence; and
send sixth indication information to the third communication device in a case that the use manner is the second manner, where the sixth indication information is used to indicate the third Walsh sequence and the fourth Walsh sequence or indicate the dimension of the Walsh sequence group, the sequence number of the third Walsh sequence, and the sequence number of the fourth Walsh sequence.

In an embodiment, the transmitting module 1204 is further configured to:
send the fifth indication information or the sixth indication information to the third communication device by using at least one of RRC signaling, a MAC CE, DCI, SCI, and a preamble sequence.

In an embodiment, in a case that the third indication information is used to indicate the second Walsh sequence in the Walsh sequence group or indicate the dimension of the Walsh sequence group and the sequence number of the second Walsh sequence, the determining module 1202 is configured to:
determine the second Walsh sequence based on the third indication information; and
determine the second Walsh sequence as the first target sequence.

In an embodiment, in a case that the third indication information is used to indicate the third Walsh sequence and the fourth Walsh sequence in the Walsh sequence group or indicate the dimension of the Walsh sequence group, the sequence number of the third Walsh sequence, and the sequence number of the fourth Walsh sequence, the determining module 1202 is configured to:
determine the third Walsh sequence and the fourth Walsh sequence based on the third indication information; and
determine the third Walsh sequence and the fourth Walsh sequence as the first target sequence.

In an embodiment, in a case that the first target sequence is the second Walsh sequence, the signal processing module 1203 is configured to:
perform chip-level multiplication on the second Walsh sequence and the backscatter modulation signal to obtain the second signal.

In an embodiment, in a case that the first target sequence is the third Walsh sequence and the fourth Walsh sequence, the signal processing module 1203 is configured to:
perform equal-amplitude superposition and mapping processing on the third Walsh sequence, the fourth Walsh sequence, and the backscatter modulation signal to obtain the second signal.

The apparatus 1200 in this embodiment of this application may refer to the procedure corresponding to the method 400 in the embodiments of this application. In addition, the units/modules in the apparatus 1200 and the foregoing other operations and/or functions are respectively used to implement the corresponding procedure in the method 400, and a same or equivalent technical effect can be achieved. For brevity, details are not described herein again.

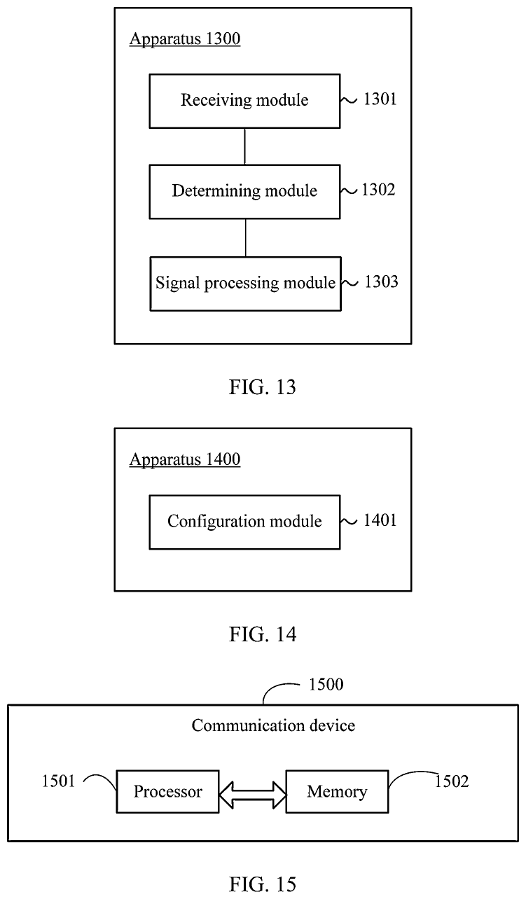

FIG. 13 is a schematic structural diagram of a signal processing apparatus according to an embodiment of this application. The apparatus may correspond to a third communication device in another embodiment. As shown in FIG. 13, the apparatus 1300 includes the following modules:
a receiving module 1301, configured to receive a first signal and a second signal, where the first signal is generated after a first communication device performs spectrum spreading on an original signal based on a first Walsh sequence, the second signal is generated by a second communication device based on a first target sequence and a backscatter modulation signal, and the backscatter modulation signal is generated after the second communication device performs modulation and backscatter on the first signal;
a determining module 1302, configured to determine a third target sequence based on seventh indication information; and
a signal processing module 1303, configured to perform spectrum de-spreading on the first signal and the second signal based on the third target sequence.

In an embodiment, the seventh indication information is configured or indicated by a fourth communication device, the fourth communication device is the first communication device, the second communication device, the third communication device, or a third-party network device, and the seventh indication information is used to indicate the third target sequence or indicate a dimension of a Walsh sequence group to which the third target sequence belongs and a sequence number of the third target sequence; or
the seventh indication information is indicated by the second communication device, and the seventh indication information is used to indicate any one of the following:
a second Walsh sequence, or a dimension of a Walsh sequence group to which the second Walsh sequence belongs and a sequence number of the second Walsh sequence, where the second Walsh sequence belongs to a same Walsh sequence group as the first Walsh sequence and is different from the first Walsh sequence;
a second target sequence, or the dimension of the Walsh sequence group and a sequence number of the second target sequence, where the sequence number of the second target sequence is equal to a modulo 2 addition of binary representations of a sequence number of the first Walsh sequence and the sequence number of the second Walsh sequence; and
a third Walsh sequence and a fourth Walsh sequence, or the dimension of the Walsh sequence group, a sequence number of the third Walsh sequence, and a sequence number of the fourth Walsh sequence, where the third Walsh sequence, the fourth Walsh sequence, and the first Walsh sequence are different from each other.

In an embodiment, in a case that the seventh indication information is indicated by the second communication device or is configured or indicated by the fourth communication device and the fourth communication device is not the third communication device, the receiving module 1301 is further configured to:
receive the seventh indication information, where
the seventh indication information is configured or indicated by using at least one of RRC signaling, a MAC CE, DCI, SCI, and a preamble sequence.

In an embodiment, in a case that the seventh indication information is used to indicate the second target sequence or indicate the dimension of the Walsh sequence group and the sequence number of the second target sequence, the determining module 1302 is configured to:
determine the second target sequence based on the seventh indication information; and
determine the second target sequence as the third target sequence.

In an embodiment, in a case that the seventh indication information is used to indicate the second Walsh sequence or indicate the dimension of the Walsh sequence group to which the second Walsh sequence belongs and the sequence number of the second Walsh sequence, the determining module 1302 is configured to:
determine the first Walsh sequence based on second indication information, where the second indication information is used to indicate the first Walsh sequence or indicate the dimension of the Walsh sequence group to which the first Walsh sequence belongs and the sequence number of the first Walsh sequence;
determine the second Walsh sequence based on the seventh indication information; and
perform chip-level multiplication on the first Walsh sequence and the second Walsh sequence to obtain the third target sequence, where the sequence number of the third target sequence is equal to a modulo 2 addition of binary representations of the sequence number of the first Walsh sequence and the sequence number of the second Walsh sequence.

In some embodiments, in a case that the seventh indication information is used to indicate the third Walsh sequence and the fourth Walsh sequence or indicate the dimension of the Walsh sequence group, the sequence number of the third Walsh sequence, and the sequence number of the fourth Walsh sequence, the determining module 1302 is configured to:
determine the first Walsh sequence based on second indication information;
determine the third Walsh sequence and the fourth Walsh sequence based on the seventh indication information; and
determine the third target sequence based on the first Walsh sequence, the third Walsh sequence, and the fourth Walsh sequence, where the third target sequence meets two of the following:
the third target sequence is a Walsh sequence in the Walsh sequence group; and
a modulo 2 addition of binary representations of the sequence number of the third target sequence and the sequence number of the first Walsh sequence, the sequence number of the third Walsh sequence, and the sequence number of the fourth Walsh sequence is 0.

In an embodiment, the second indication information is indicated by the first communication device, and in a case that the first communication device and the third communication device are not a same device, the receiving module 1301 is further configured to:
receive the second indication information, where
the second indication information is configured or indicated by using at least one of RRC signaling, a MAC CE, DCI, SCI, and a preamble sequence.

The apparatus 1300 in this embodiment of this application may refer to the procedure corresponding to the method 500 in the embodiments of this application. In addition, the units/modules in the apparatus 1300 and the foregoing other operations and/or functions are respectively used to implement the corresponding procedure in the method 500, and a same or equivalent technical effect can be achieved. For brevity, details are not described herein again.

FIG. 14 is a schematic structural diagram of a signal processing apparatus according to an embodiment of this application. The apparatus may correspond to a fourth communication device in another embodiment. As shown in FIG. 14, the apparatus 1400 includes the following modules:
a configuration module 1401, configured to configure or indicate at least one of a first Walsh sequence, a first target sequence, and a third target sequence, or at least one of a dimension of a Walsh sequence group, a sequence number of the first Walsh sequence, a sequence number of the first target sequence, and a sequence number of the third target sequence to a first communication device, a second communication device, and a third communication device, where
the first Walsh sequence is used by the first communication device to perform spectrum spreading on an original signal to generate a first signal, the first target sequence is used by the second communication device to generate a second signal based on a backscatter modulation signal, the backscatter modulation signal is generated by performing modulation and backscatter on the first signal, and the third target sequence is used by the third communication device to perform spectrum de-spreading on the first signal and the second signal.

In an embodiment, the apparatus is the first communication device, the second communication device, the third communication device, or a third-party network device.

In an embodiment, a configuration or indication manner of the apparatus includes at least one of the following:
RRC signaling, a MAC CE, DCI, SCI, and a preamble sequence.

In an embodiment, the configuration module 1401 is further configured to:
configure or indicate a use manner of the first target sequence to the second communication device, where the use manner includes a first manner or a second manner, the first manner represents a manner of performing chip-level multiplication on the first target sequence and the first Walsh sequence based on a multiplication principle, and the second manner represents a manner of performing equal-amplitude superposition and mapping processing on the first target sequence and the first Walsh sequence based on an equal-amplitude superposition principle; and
configure or indicate a generation manner of the third target sequence to the third communication device, where the generation manner includes: generating the third target sequence through chip-level multiplication based on the multiplication principle or generating the third target sequence through equal-amplitude superposition and mapping processing based on the equal-amplitude superposition principle.

In an embodiment, the configuration module 1401 configures or indicates the use manner of the first target sequence or the generation manner of the third target sequence by using at least one of the following:
RRC signaling, a MAC CE, DCI, SCI, and a physical frame preamble.

The apparatus 1400 in this embodiment of this application may refer to the procedure corresponding to the method 600 in the embodiments of this application. In addition, the units/modules in the apparatus 1400 and the foregoing other operations and/or functions are respectively used to implement the corresponding procedure in the method 600, and a same or equivalent technical effect can be achieved. For brevity, details are not described herein again.

The signal processing apparatus in this embodiment of this application may be an electronic device, for example, an electronic device with an operating system, or may be a component in the electronic device, for example, an integrated circuit or a chip. The electronic device may be a terminal, or may be another device other than the terminal. For example, the terminal may include but is not limited to the foregoing listed type of the terminal 11. The another device may be a server, a network attached storage (Network Attached Storage, NAS), or the like. This is not specifically limited in this embodiment of this application.

The signal processing apparatus provided in this embodiment of this application can implement the processes implemented in the method embodiments of FIG. 3 to FIG. 6, and achieve a same technical effect. To avoid repetition, details are not described herein again.

For example, as shown in FIG. 15, an embodiment of this application further provides a communication device 1500, including a processor 1501 and a memory 1502. The memory 1502 stores a program or an instruction that can be run on the processor 1501. For example, when the communication device 1500 is a terminal, the program or the instruction is executed by the processor 1501 to implement the steps of the foregoing signal processing method embodiment, and a same technical effect can be achieved. When the communication device 1500 is a network side device, the program or the instruction is executed by the processor 1501 to implement the processes of the foregoing signal processing method embodiment, and a same technical effect can be achieved. To avoid repetition, details are not described herein again.

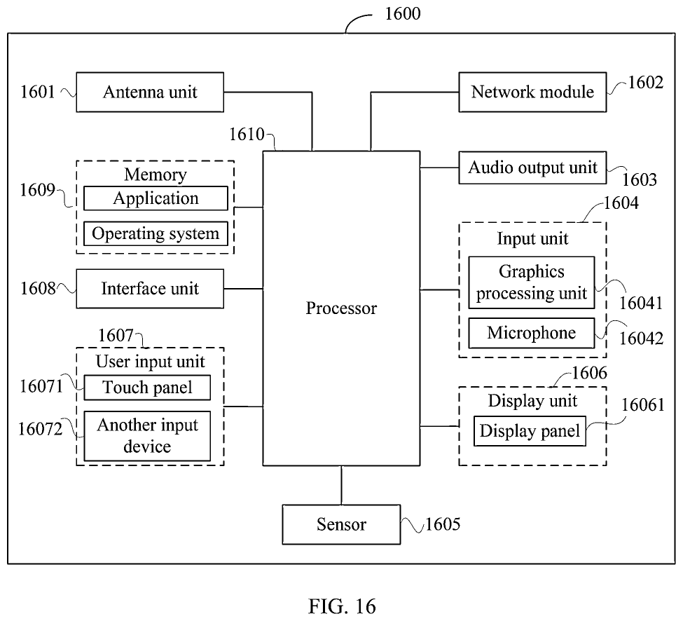

An embodiment of this application further provides a communication device, including a processor and a communication interface. The processor is configured to: determine a first Walsh sequence based on first indication information; and perform spectrum spreading on an original signal based on the first Walsh sequence to generate a first signal; and the communication interface is configured to send the first signal to a second communication device, where the communication device is a device that provides a radio frequency carrier source for the second communication device. In some alternative embodiments, the communication interface is configured to receive a first signal, where the first signal is generated after a first communication device performs spectrum spreading on an original signal based on a first Walsh sequence; the processor is configured to: determine a first target sequence based on third indication information; and generate a second signal based on the first target sequence and a backscatter modulation signal, where the backscatter modulation signal is generated by performing modulation and backscatter on the first signal; and the communication interface is configured to send the second signal to a third communication device. In some alternative embodiments, the communication interface is configured to receive a first signal and a second signal, where the first signal is generated after a first communication device performs spectrum spreading on an original signal based on a first Walsh sequence, the second signal is generated by a second communication device based on a first target sequence and a backscatter modulation signal, and the backscatter modulation signal is generated after the second communication device performs modulation and backscatter on the first signal; the processor is configured to determine a third target sequence based on seventh indication information; and the communication interface is configured to perform spectrum de-spreading on the first signal and the second signal based on the third target sequence. In some alternative embodiments, the communication interface is configured to configure or indicate at least one of a first Walsh sequence, a first target sequence, and a third target sequence, or at least one of a dimension of a Walsh sequence group, a sequence number of the first Walsh sequence, a sequence number of the first target sequence, and a sequence number of the third target sequence to a first communication device, a second communication device, and a third communication device, where the first Walsh sequence is used by the first communication device to perform spectrum spreading on an original signal to generate a first signal, the first target sequence is used by the second communication device to generate a second signal based on a backscatter modulation signal, the backscatter modulation signal is generated by performing modulation and backscatter on the first signal, and the third target sequence is used by the third communication device to perform spectrum de-spreading on the first signal and the second signal. The embodiment of the communication device corresponds to the foregoing method embodiment on the side of the first communication device, or corresponds to the foregoing method embodiment on the side of second communication device, or corresponds to the foregoing method embodiment on the side of the third communication device, or corresponds to the foregoing method embodiment of the side of the fourth communication device. The implementation processes and implementations of the foregoing method embodiment may be applicable to the embodiment of the communication device, and a same technical effect can be achieved. For example, FIG. 16 is a schematic structural diagram of hardware of a communication device according to an embodiment of this application.

The communication device 1600 includes but is not limited to a part of components such as an antenna unit 1601, a network module 1602, an audio output unit 1603, an input unit 1604, a sensor 1605, a display unit 1606, a user input unit 1607, an interface unit 1608, a memory 1609, and a processor 1610.

A person skilled in the art can understand that the communication device 1600 may further include the power supply (for example, a battery) that supplies power to each component. The power supply may be logically connected to the processor 1610 by using a power supply management system, so as to manage functions such as charging, discharging, and power consumption by using the power supply management system. The structure of the communication device shown in FIG. 16 does not constitute a limitation on the communication device, and the communication device may include more or fewer components than those shown in the figure, or combine some components, or have different component arrangements. Details are not described herein again.

It should be understood that, in this embodiment of this application, the input unit 1604 may include a Graphics Processing Unit (GPU) 16041 and a microphone 16042, and the GPU 16041 processes image data of a still image or a video that is obtained by an image capturing apparatus (for example, a camera) in a video capturing mode or an image capturing mode. The display unit 1606 may include a display panel 16061. The display panel 16061 may be configured in a form such as a liquid crystal display or an organic light-emitting diode. The user input unit 1607 includes at least one of a touch panel 16071 and another input device 16072. The touch panel 16071 is also referred to as a touchscreen. The touch panel 16071 may include two parts: a touch detection apparatus and a touch controller. The another input device 16072 may include but is not limited to a physical keyboard, a functional button (such as a volume control button or a power on/off button), a trackball, a mouse, and a joystick. Details are not described herein.

In this embodiment of this application, after receiving downlink data from a network side device, the antenna unit 1601 may transmit the downlink data to the processor 1610 for processing. In addition, the antenna unit 1601 may send uplink data to the network side device. Usually, the antenna unit 1601 includes but is not limited to an antenna, an amplifier, a transceiver, a coupler, a low noise amplifier, a duplexer, and the like.

The memory 1609 may be configured to store a software program or an instruction and various data. The memory 1609 may mainly include a first storage area for storing a program or an instruction and a second storage area for storing data. The first storage area may store an operating system, and an application or an instruction required by at least one function (for example, a sound playing function or an image playing function). In addition, the memory 1609 may be a volatile memory or a non-volatile memory, or the memory 1609 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1609 in this embodiment of this application includes but is not limited to these memories and a memory of any other proper type.

The processor 1610 may include one or more processing units. In some embodiments, an application processor and a modem processor are integrated into the processor 1610. The application processor mainly processes an operating system, a user interface, an application, and the like. The modem processor mainly processes a wireless communication signal, for example, a baseband processor. It can be understood that the modem processor may not be integrated into the processor 1610.

The processor 1610 is configured to: determine a first Walsh sequence based on first indication information; and perform spectrum spreading on an original signal based on the first Walsh sequence to generate a first signal; and the communication interface is configured to send the first signal to a second communication device, where the communication device is a device that provides a radio frequency carrier source for the second communication device; or
the antenna unit 1601 is configured to receive a first signal, where the first signal is generated after a first communication device performs spectrum spreading on an original signal based on a first Walsh sequence; the processor 1610 is configured to determine a first target sequence based on third indication information; and generate a second signal based on the first target sequence and a backscatter modulation signal, where the backscatter modulation signal is generated by performing modulation and backscatter on the first signal; and the antenna unit 1601 is configured to send the second signal to a third communication device; or
the antenna unit 1601 is configured to receive a first signal and a second signal, where the first signal is generated after a first communication device performs spectrum spreading on an original signal based on a first Walsh sequence, the second signal is generated by a second communication device based on a first target sequence and a backscatter modulation signal, and the backscatter modulation signal is generated after the second communication device performs modulation and backscatter on the first signal; the processor 1610 is configured to determine a third target sequence based on seventh indication information; and the antenna unit 1601 is configured to perform spectrum de-spreading on the first signal and the second signal based on the third target sequence; or
the antenna unit 1601 is configured to configure or indicate at least one of a first Walsh sequence, a first target sequence, and a third target sequence, or at least one of a dimension of a Walsh sequence group, a sequence number of the first Walsh sequence, a sequence number of the first target sequence, and a sequence number of the third target sequence to a first communication device, a second communication device, and a third communication device, where the first Walsh sequence is used by the first communication device to perform spectrum spreading on an original signal to generate a first signal, the first target sequence is used by the second communication device to generate a second signal based on a backscatter modulation signal, the backscatter modulation signal is generated by performing modulation and backscatter on the first signal, and the third target sequence is used by the third communication device to perform spectrum de-spreading on the first signal and the second signal.

In this embodiment of this application, when transmitting a signal to a second communication device, a first communication device may perform spectrum spreading on an original signal based on an indicated Walsh sequence to obtain a first signal, and send the first signal to the second communication device. When transmitting a backscatter signal to a third communication device, the second communication device may generate a second signal based on the backscatter signal and an indicated first target sequence, and send the second signal to the third communication device. After receiving the first signal and the second signal, the third communication device may perform spectrum de-spreading on the first signal and the second signal based on an indicated third target sequence. Both the first signal and the second signal are signals processed by using Walsh sequences. Therefore, when performing spectrum de-spreading on the first signal and the second signal based on the Walsh sequence, the third communication device may eliminate an interference signal and recover a useful backscatter signal based on characteristics of the Walsh sequence, so as to effectively eliminate the interference signal, thereby ensuring communication performance of backscatter communication and improving transmission efficiency, a transmission distance, and transmission reliability of backscatter communication.

An embodiment of this application further provides a communication device, including a processor and a communication interface. The processor is configured to: determine a first Walsh sequence based on first indication information; and perform spectrum spreading on an original signal based on the first Walsh sequence to generate a first signal; and the communication interface is configured to send the first signal to a second communication device, where the communication device is a device that provides a radio frequency carrier source for the second communication device. In some alternative embodiments, the communication interface is configured to receive a first signal, where the first signal is generated after a first communication device performs spectrum spreading on an original signal based on a first Walsh sequence; the processor is configured to: determine a first target sequence based on third indication information; and generate a second signal based on the first target sequence and a backscatter modulation signal, where the backscatter modulation signal is generated by performing modulation and backscatter on the first signal; and the communication interface is configured to send the second signal to a third communication device. In some alternative embodiments, the communication interface is configured to receive a first signal and a second signal, where the first signal is generated after a first communication device performs spectrum spreading on an original signal based on a first Walsh sequence, the second signal is generated by a second communication device based on a first target sequence and a backscatter modulation signal, and the backscatter modulation signal is generated after the second communication device performs modulation and backscatter on the first signal; the processor is configured to determine a third target sequence based on seventh indication information; and the communication interface is configured to perform spectrum de-spreading on the first signal and the second signal based on the third target sequence. In some alternative embodiments, the communication interface is configured to configure or indicate at least one of a first Walsh sequence, a first target sequence, and a third target sequence, or at least one of a dimension of a Walsh sequence group, a sequence number of the first Walsh sequence, a sequence number of the first target sequence, and a sequence number of the third target sequence to a first communication device, a second communication device, and a third communication device, where the first Walsh sequence is used by the first communication device to perform spectrum spreading on an original signal to generate a first signal, the first target sequence is used by the second communication device to generate a second signal based on a backscatter modulation signal, the backscatter modulation signal is generated by performing modulation and backscatter on the first signal, and the third target sequence is used by the third communication device to perform spectrum de-spreading on the first signal and the second signal. The embodiment of the communication device corresponds to the foregoing method embodiment on the side of the first communication device, or corresponds to the foregoing method embodiment on the side of second communication device, or corresponds to the foregoing method embodiment on the side of the third communication device, or corresponds to the foregoing method embodiment of the side of the fourth communication device. The implementation processes and implementations of the foregoing method embodiment may be applicable to the embodiment of the communication device, and a same technical effect can be achieved.

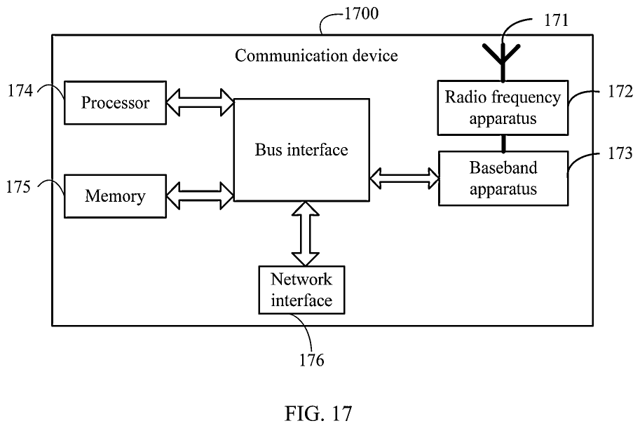

For example, an embodiment of this application further provides a communication device. As shown in FIG. 17, the communication device 1700 includes an antenna 171, a radio frequency apparatus 172, a baseband apparatus 173, a processor 174, and a memory 175. The antenna 171 is connected to the radio frequency apparatus 172. In an uplink direction, the radio frequency apparatus 172 receives information by using the antenna 171, and sends the received information to the baseband apparatus 173 for processing. In a downlink direction, the baseband apparatus 173 processes information that needs to be sent, and sends processed information to the radio frequency apparatus 172. The radio frequency apparatus 172 processes the received information, and sends processed information by using the antenna 171.

In the foregoing embodiment, the methods performed by the first communication device, the second communication device, the third communication device, and the fourth communication device may be implemented in the baseband apparatus 173. The baseband apparatus 173 includes a baseband processor.

The baseband apparatus 173 may include, for example, at least one baseband board, where a plurality of chips is disposed on the baseband board. As shown in FIG. 17, one chip is, for example, the baseband processor, is connected to the memory 175 through a bus interface, to invoke a program in the memory 175 to perform the operations of the communication device shown in the foregoing method embodiment.

The communication device may further include a network interface 176, and the interface is, for example, a Common Public Radio Interface (CPRI).

For example, the communication device 1700 in this embodiment of the present application further includes an instruction or a program that is stored in the memory 175 and that can be run on the processor 174. The processor 174 invokes the instruction or the program in the memory 175 to perform the method performed by the modules shown in FIG. 11 to FIG. 14, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing signal processing method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing signal processing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing signal processing method embodiment, and a same technical effect can be achieved. To avoid repetition, details are not described herein again.

An embodiment of this application further provides a signal processing system, including at least two of a first communication device, a second communication device, a third communication device, and a fourth communication device. The first communication device may be configured to perform the steps of the signal processing method shown in FIG. 3, the second communication device may be configured to perform the steps of the signal processing method shown in FIG. 4, the third communication device may be configured to perform the steps of the signal processing method shown in FIG. 5, and the fourth communication device may be configured to perform the steps of the signal processing method shown in FIG. 6.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In some embodiments, the technical solutions of this application entirely or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above implementations, and the above implementations are merely illustrative but not restrictive. Under the enlightenment of this application, a person of ordinary skill in the art can make many forms without departing from the purpose of this application and the protection scope of the claims, all of which fall within the protection of this application.

1. A signal processing method, comprising:
determining, by a first communication device, a first Walsh sequence based on first indication information;
performing, by the first communication device, spectrum spreading on an original signal based on the first Walsh sequence to generate a first signal; and
transmitting, by the first communication device, the first signal to a second communication device, wherein the first communication device is a device that provides a radio frequency carrier source for the second communication device.

2. The signal processing method according to claim 1, wherein the first indication information is used to indicate the first Walsh sequence or indicate a dimension of a Walsh sequence group to which the first Walsh sequence belongs and a sequence number of the first Walsh sequence.

3. The signal processing method according to claim 1, wherein the first indication information is configured or indicated by a fourth communication device, and the fourth communication device is the first communication device, the second communication device, a third communication device, or a third-party network device.

4. The signal processing method according to claim 3, wherein when the first indication information is configured or indicated by the fourth communication device and the fourth communication device is different from the first communication device, before determining, by the first communication device, the first Walsh sequence based on the first indication information, the method further comprises:
receiving the first indication information, wherein
the first indication information is configured or indicated by the fourth communication device by using at least one of Radio Resource Control (RRC) signaling, a Medium Access Control Control Element (MAC CE), Downlink Control Information (DCI), Sidelink Control Information (SCI), or a preamble sequence.

5. The signal processing method according to claim 3, further comprising:
transmitting, by the first communication device, second indication information to the second communication device and the third communication device when the first communication device and the third communication device are different devices; and
transmitting, by the first communication device, the second indication information to the second communication device when the first communication device and the third communication device are a same device, wherein
the second indication information is used to indicate the first Walsh sequence or indicate a dimension of a Walsh sequence group to which the first Walsh sequence belongs and a sequence number of the first Walsh sequence.

6. The signal processing method according to claim 5, wherein transmitting, by the first communication device, the second indication information comprises:
transmitting, by the first communication device, the second indication information by using at least one of RRC signaling, a MAC CE, DCI, SCI, or a preamble sequence.

7. A signal processing method, comprising:
receiving, by a second communication device, a first signal, wherein the first signal is generated after a first communication device performs spectrum spreading on an original signal based on a first Walsh sequence;
determining, by the second communication device, a first target sequence based on third indication information;
generating, by the second communication device, a second signal based on the first target sequence and a backscatter modulation signal, wherein the backscatter modulation signal is generated by performing modulation and backscatter on the first signal; and
transmitting, by the second communication device, the second signal to a third communication device.

8. The signal processing method according to claim 7, wherein the third indication information is indicated by the first communication device, and the third indication information is used to indicate the first Walsh sequence or indicate a dimension of a Walsh sequence group to which the first Walsh sequence belongs and a sequence number of the first Walsh sequence; or
the third indication information is configured or indicated by a fourth communication device, wherein the fourth communication device is the first communication device, the second communication device, the third communication device, or a third-party network device, and the third indication information is used to indicate any one of the following:
a second Walsh sequence in the Walsh sequence group, or the dimension of the Walsh sequence group and a sequence number of the second Walsh sequence, wherein the second Walsh sequence is different from the first Walsh sequence, or
a third Walsh sequence and a fourth Walsh sequence in the Walsh sequence group, or the dimension of the Walsh sequence group, a sequence number of the third Walsh sequence, and a sequence number of the fourth Walsh sequence, wherein the third Walsh sequence, the fourth Walsh sequence, and the first Walsh sequence are different from each other.

9. The signal processing method according to claim 8, wherein when the third indication information is indicated by the first communication device, or when the third indication information is configured or indicated by the fourth communication device and the fourth communication device is not the second communication device, the method further comprises:
receiving the third indication information, wherein
the third indication information is configured or indicated by using at least one of Radio Resource Control (RRC) signaling, a Medium Access Control Control Element (MAC CE), Downlink Control Information (DCI), Sidelink Control Information (SCI), or a preamble sequence.

10. The signal processing method according to claim 8, wherein when the third indication information is used to indicate the first Walsh sequence or indicate the dimension of the Walsh sequence group to which the first Walsh sequence belongs and the sequence number of the first Walsh sequence, determining, by the second communication device, the first target sequence based on the third indication information comprises:
determining the first Walsh sequence based on the third indication information;
determining a use manner of the first target sequence based on fourth indication information,
wherein:
the use manner comprises a first manner or a second manner,
the first manner represents a manner of performing chip-level multiplication on the first target sequence and the first Walsh sequence based on a multiplication principle, and
the second manner represents a manner of performing equal-amplitude superposition and mapping processing on the first target sequence and the first Walsh sequence based on an equal-amplitude superposition principle; and
determining the first target sequence based on the first Walsh sequence and the use manner.

11. The signal processing method according to claim 10,
wherein:
the fourth indication information is configured or indicated by a fourth communication device, and the fourth communication device is the first communication device, the second communication device, the third communication device, or a third-party network device; and
when the fourth communication device is not the second communication device, the method further comprises:
receiving the fourth indication information, wherein the fourth indication information is configured or indicated by using at least one of Radio Resource Control (RRC) signaling, a Medium Access Control Control Element (MAC CE), Downlink Control Information (DCI), Sidelink Control Information (SCI), or a preamble sequence.

12. The signal processing method according to claim 10, wherein determining the first target sequence based on the first Walsh sequence and the use manner comprises:
when the use manner is the first manner, determining the second Walsh sequence based on the first Walsh sequence, and determining the second Walsh sequence as the first target sequence; and
when the use manner is the second manner, determining the third Walsh sequence and the fourth Walsh sequence based on the first Walsh sequence, and determining the third Walsh sequence and the fourth Walsh sequence as the first target sequence.

13. The signal processing method according to claim 12, further comprising:
transmitting fifth indication information to the third communication device when the use manner is the first manner, wherein the fifth indication information is used to indicate any one of the following:
the second Walsh sequence, or the dimension of the Walsh sequence group to which the second Walsh sequence belongs and the sequence number of the second Walsh sequence, or
a second target sequence, or the dimension of the Walsh sequence group and a sequence number of the second target sequence, wherein the sequence number of the second target sequence is equal to a modulo 2 addition of binary representations of the sequence number of the first Walsh sequence and the sequence number of the second Walsh sequence; and
transmitting sixth indication information to the third communication device when the use manner is the second manner, wherein the sixth indication information is used to indicate the third Walsh sequence and the fourth Walsh sequence or indicate the dimension of the Walsh sequence group, the sequence number of the third Walsh sequence, and the sequence number of the fourth Walsh sequence.

14. The signal processing method according to claim 13, wherein transmitting the fifth indication information or the sixth indication information to the third communication device comprises:
transmitting the fifth indication information or the sixth indication information to the third communication device by using at least one of Radio Resource Control (RRC) signaling, a Medium Access Control Control Element (MAC CE), Downlink Control Information (DCI), Sidelink Control Information (SCI), or a preamble sequence.

15. The signal processing method according to claim 8, wherein when the third indication information is used to indicate the second Walsh sequence in the Walsh sequence group or indicate the dimension of the Walsh sequence group and the sequence number of the second Walsh sequence, determining, by the second communication device, the first target sequence based on the third indication information comprises:
determining the second Walsh sequence based on the third indication information; and
determining the second Walsh sequence as the first target sequence.

16. The signal processing method according to claim 8, wherein when the third indication information is used to indicate the third Walsh sequence and the fourth Walsh sequence in the Walsh sequence group or indicate the dimension of the Walsh sequence group, the sequence number of the third Walsh sequence, and the sequence number of the fourth Walsh sequence, determining, by the second communication device, the first target sequence based on the third indication information comprises:
determining the third Walsh sequence and the fourth Walsh sequence based on the third indication information; and
determining the third Walsh sequence and the fourth Walsh sequence as the first target sequence.

17. The signal processing method according to claim 12, wherein when the first target sequence is the second Walsh sequence, generating, by the second communication device, the second signal based on the first target sequence and the backscatter modulation signal comprises:
performing chip-level multiplication on the second Walsh sequence and the backscatter modulation signal to obtain the second signal.

18. The signal processing method according to claim 12, wherein when the first target sequence is the third Walsh sequence and the fourth Walsh sequence, generating, by the second communication device, the second signal based on the first target sequence and the backscatter modulation signal comprises:
performing equal-amplitude superposition and mapping processing on the third Walsh sequence, the fourth Walsh sequence, and the backscatter modulation signal to obtain the second signal.

19. A signal processing method, comprising:
receiving, by a third communication device, a first signal and a second signal, wherein the first signal is generated after a first communication device performs spectrum spreading on an original signal based on a first Walsh sequence, and the second signal is generated by a second communication device based on a first target sequence and a backscatter modulation signal, wherein the backscatter modulation signal is generated after the second communication device performs modulation and backscatter on the first signal;
determining, by the third communication device, a third target sequence based on seventh indication information; and
performing, by the third communication device, spectrum de-spreading on the first signal and the second signal based on the third target sequence.

20. The signal processing method according to claim 19,
wherein:
the seventh indication information is configured or indicated by a fourth communication device, wherein the fourth communication device is the first communication device, the second communication device, the third communication device, or a third-party network device, and the seventh indication information is used to indicate the third target sequence or indicate a dimension of a Walsh sequence group to which the third target sequence belongs and a sequence number of the third target sequence; or
the seventh indication information is indicated by the second communication device, and the seventh indication information is used to indicate any one of the following:
a second Walsh sequence, or a dimension of a Walsh sequence group to which the second Walsh sequence belongs and a sequence number of the second Walsh sequence, wherein the second Walsh sequence belongs to a same Walsh sequence group as the first Walsh sequence and is different from the first Walsh sequence,
a second target sequence, or the dimension of the Walsh sequence group and a sequence number of the second target sequence, wherein the sequence number of the second target sequence is equal to a modulo 2 addition of binary representations of a sequence number of the first Walsh sequence and the sequence number of the second Walsh sequence; or
a third Walsh sequence and a fourth Walsh sequence, or the dimension of the Walsh sequence group, a sequence number of the third Walsh sequence, and a sequence number of the fourth Walsh sequence, wherein the third Walsh sequence, the fourth Walsh sequence, and the first Walsh sequence are different from each other.
